(19) United States
(12) Patent Application Publication
(10) Pub. No.: US 2026/0288279 A1
(43) Pub. Date: Sep. 24, 2026

(54) ELECTRONIC DEVICE AND METHOD FOR DRIVING THE SAME

(71) Applicant: Samsung Display Co., Ltd., Yongin-si (KR)

(72) Inventors: MIYOUNG KIM, Yongin-si (KR); SANGHYUN LIM, Yongin-si (KR)

(21) Appl. No.: 19/406,430

(22) Filed: Dec. 2, 2025

(30) Foreign Application Priority Data
Mar. 20, 2025 (KR) 10-2025-0035646

(51) Int. Cl. G06F 3/041; G06F 3/044

(52) U.S. Cl. CPC G06F 3/0418; G06F 3/0442; G06F 3/0446; G06F 2203/04111

(57) ABSTRACT

Disclosed is an electronic device including a display layer, a sensor layer above the display layer, and a sensor driver configured to drive the sensor layer, and including a coordinate corrector configured to output a corrected sensing signal by applying an offset to a sensing signal for an input device sensed in the sensor layer, and a coordinate calculator configured to calculate coordinate information of the input device based on the corrected sensing signal, and wherein a number of negative data in the corrected sensing signal is less than a number of negative data in the sensing signal.

### CROSS-REFERENCE TO RELATED APPLICATION

The present application claims priority to, and the benefit of, Korean Patent Application No. 10-2025-0035646, filed on Mar. 20, 2025, in the Korean Intellectual Property Office, the entire disclosure of which is incorporated herein by reference.

### BACKGROUND

Embodiments of the present disclosure described herein relate to an electronic device improved in coordinate reliability, and a method for driving the electronic device.

Multimedia electronic devices, such as a television (TV), a cellular phone, a tablet computer, a laptop computer, a navigation, or a game console, include a display panel that displays an image. Electronic devices may include a sensor layer (or an input sensor) that provides a touch-based input manner for enabling a user to intuitively, conveniently, and suitably input information or a command, in addition to a general input manner, such as a button, a keyboard, or a mouse, The sensor layer may sense a touch or an input of a user. Meanwhile, there is an increasing demand for using a pen for a fine touch input for the user who is accustomed to entering information by using writing instruments or for a corresponding application (e.g. an application program for sketching or drawing).

### SUMMARY

Embodiments of the present disclosure provide an electronic device improved in coordinate reliability and a method for driving the electronic device.

According to one or more embodiments, an electronic device may include a display layer, a sensor layer above the display layer, and a sensor driver configured to drive the sensor layer, and including a coordinate corrector configured to output a corrected sensing signal by applying an offset to a sensing signal for an input device sensed in the sensor layer, and a coordinate calculator configured to calculate coordinate information of the input device based on the corrected sensing signal, and wherein a number of negative data in the corrected sensing signal is less than a number of negative data in the sensing signal.

The sensing signal may be generated from a differential signal obtained by differentially sensing channels based on a current induced to the sensor layer by the input device.

The sensing signal may include a first peak value having a magnitude with a negative value, a second peak value having a magnitude with a positive value, and a third peak value having a magnitude with a negative value.

The offset may be based on the first peak value or the third peak value.

The offset may be based on a greater value of the magnitude of the first peak value or the magnitude of the third peak value.

The first peak value and the third peak value may have a same magnitude.

The offset may be substantially equal to the magnitude of the first peak value and the magnitude of the third peak value.

The corrected sensing signal may include a first corrected peak value corresponding to the first peak value, a second corrected peak value corresponding to the second peak value, and a third corrected peak value corresponding to the third peak value, wherein at least one of a magnitude of the first corrected peak value or a magnitude of the third corrected peak value has a value of zero.

The magnitude of the first corrected peak value may have a value of zero, wherein the magnitude of the third corrected peak value has a negative value.

The coordinate calculator may be configured to perform a center-of-mass manner using n pieces of data respectively at opposite sides of the second corrected peak value.

The coordinate calculator may be configured to disregard data having a negative value among data of the corrected sensing signal.

The coordinate corrector may be configured to identically apply the offset to all data of the sensing signal.

The sensor layer may include first electrodes extending in a first direction, second electrodes extending in a second direction crossing the first direction, and third electrodes extending in the first direction, and insulated from the second electrodes.

The sensor driver may be configured to drive a first mode for sensing a touch, or a second mode for sensing the input device and including a charging-and-sensing mode.

The second mode may include a charging-driving mode and a pen-sensing-driving mode, wherein the coordinate information of the input device is calculated in the pen-sensing-driving mode.

According to one or more embodiments of the present disclosure, a method for driving an electronic device may include receiving a sensing signal from a sensor layer based on a current induced by an input device, providing the sensing signal to a sensor driver, outputting a corrected sensing signal by applying an offset to the sensing signal, and calculating coordinate information based on the corrected sensing signal, wherein a number of negative data distributed in the corrected sensing signal is less than a number of negative data distributed in the sensing signal.

The sensing signal may include a first peak value having a magnitude with a negative value, a second peak value having a magnitude with a positive value, and a third peak value having a magnitude with a negative value.

The method may further include calculating the offset based on the first peak value or the second peak value.

The method may further include calculating the offset based on a greater value of the magnitude of the first peak value or the magnitude of the third peak value.

The corrected sensing signal may include a first corrected peak value corresponding to the first peak value, a second corrected peak value corresponding to the second peak value, and a third corrected peak value corresponding to the third peak value, wherein the calculating of the coordinate information includes performing a center-of-mass manner using n pieces of data respectively on opposite sides of the second corrected peak value.

### BRIEF DESCRIPTION OF THE DRAWINGS

The above and other aspects of the present disclosure will become apparent by describing in detail embodiments thereof with reference to the accompanying drawings.

FIG. 1 is a block diagram of an electronic device according to one or more embodiments of the present disclosure.

FIG. 2 illustrates schematic views of electronic devices according to various embodiments.

FIG. 3 is a perspective view of an electronic device according to one or more embodiments of the present disclosure.

FIG. 4 is a cross-sectional view of a display module according to one or more embodiments of the present disclosure.

FIG. 5 is a view to describe an operation of an electronic device according to one or more embodiments of the present disclosure.

FIG. 6A is a cross-sectional view of a display module according to one or more embodiments of the present disclosure.

FIG. 6B is a cross-sectional view illustrating some components of a sensor layer according to one or more embodiments of the present disclosure.

FIG. 7 is a plan view illustrating a sensor layer according to one or more embodiments of the present disclosure.

FIG. 8A is a plan view illustrating a first conductive layer of a sensing unit according to one or more embodiments of the present disclosure,

FIG. 8B is an enlarged plan view of an XX′ region illustrated in FIG. 8A according to one or more embodiments of the present disclosure.

FIG. 9A is a plan view illustrating a second conductive layer of a sensing unit according to one or more embodiments of the present disclosure.

FIG. 9B is an enlarged plan view of a YY′ region illustrated in FIG. 9A according to one or more embodiments of the present disclosure.

FIG. 10 is a view illustrating an operation of a sensor driver according to one or more embodiments of the present disclosure.

FIG. 11 is a view illustrating the operation of a sensor driver according to one or more embodiments of the present disclosure.

FIG. 12 is a view to describe a first mode according to one or more embodiments of the present disclosure.

FIG. 13 is a view to describe a second mode, such as a charging-driving mode, according to one or more embodiments of the present disclosure.

FIG. 14A is a graph illustrating a waveform of a first signal according to one or more embodiments of the present disclosure.

FIG. 14B is a graph illustrating a waveform of a second signal according to one or more embodiments of the present disclosure.

FIG. 15A is a view to describe a second mode according to one or more embodiments of the present disclosure.

FIG. 15B is a view to describe a second mode based on one sensing unit according to one or more embodiments of the present disclosure.

FIG. 16 is a flowchart illustrating a method for driving an electronic device according to one or more embodiments of the present disclosure.

FIG. 17 is a block diagram of a sensor driver according to one or more embodiments of the present disclosure.

FIG. 18 is a view illustrating the magnitude and the direction of an induced current generated in an input device and a first electrodes according to one or more embodiments of the present disclosure.

FIG. 19 is a graph of sensing current values illustrating sensing signals and corrected sensing signals obtained from differential pairs of channels according to one or more embodiments of the present disclosure.

FIG. 20 is a view illustrating a magnitude and a direction of induced currents generated between an input device and first electrodes according to one or more embodiments of the present disclosure.

FIG. 21 is a graph of sensing current values illustrating sensing signals and corrected sensing signals obtained from differential pairs of channels according to one or more embodiments of the present disclosure.

### DETAILED DESCRIPTION

Aspects of some embodiments of the present disclosure and methods of accomplishing the same may be understood more readily by reference to the detailed description of embodiments and the accompanying drawings. The described embodiments are provided as examples so that this disclosure will be thorough and complete, and will fully convey the aspects of the present disclosure to those skilled in the art. Accordingly, processes, elements, and techniques that are redundant, that are unrelated or irrelevant to the description of the embodiments, or that are not necessary to those having ordinary skill in the art for a complete understanding of the aspects of the present disclosure may be omitted. Unless otherwise noted, like reference numerals, characters, or combinations thereof denote like elements throughout the attached drawings and the written description, and thus, repeated descriptions thereof may be omitted.

The described embodiments may have various modifications and may be embodied in different forms, and should not be construed as being limited to only the illustrated embodiments herein. The use of “can,” “may,” or “may not” in describing an embodiment corresponds to one or more embodiments of the present disclosure.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

In the drawings, the relative sizes of elements, layers, and regions may be exaggerated for clarity and/or descriptive purposes. In other words, because the sizes and thicknesses of elements in the drawings are arbitrarily illustrated for convenience of description, the disclosure is not limited thereto. Additionally, the use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified.

Various embodiments are described herein with reference to sectional illustrations that are schematic illustrations of embodiments and/or intermediate structures. As such, variations from the shapes of the illustrations as a result of, for example, manufacturing techniques and/or tolerances, are to be expected. Further, specific structural or functional descriptions disclosed herein are merely illustrative for the purpose of describing embodiments according to the concept of the present disclosure. Thus, embodiments disclosed herein should not be construed as limited to the illustrated shapes of elements, layers, or regions, but are to include deviations in shapes that result from, for instance, manufacturing.

For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place.

Spatially relative terms, such as “beneath,” “below,” “lower,” “lower side,” “under,” “above,” “upper,” “over,” “higher,” “upper side,” “side” (e.g., as in “sidewall”), and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below,” “beneath,” “or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly. Similarly, when a first part is described as being arranged “on” a second part, this indicates that the first part is arranged at an upper side or a lower side of the second part without the limitation to the upper side thereof on the basis of the gravity direction.

Further, the phrase “in a plan view” means when an object portion is viewed from above, and the phrase “in a schematic cross-sectional view” means when a schematic cross-section taken by vertically cutting an object portion is viewed from the side. The terms “overlap” or “overlapped” mean that a first object may be above or below or to a side of a second object, and vice versa. Additionally, the term “overlap” may include stack, face or facing, extending over, covering, or partly covering or any other suitable term as would be appreciated and understood by those of ordinary skill in the art. The expression “not overlap” may include meaning, such as “apart from” or “set aside from” or “offset from” and any other suitable equivalents as would be appreciated and understood by those of ordinary skill in the art. The terms “face” and “facing” may mean that a first object may directly or indirectly oppose a second object. In a case in which a third object intervenes between a first and second object, the first and second objects may be understood as being indirectly opposed to one another, although still facing each other.

It will be understood that when an element, layer, region, or component (e.g., an apparatus, a device, a circuit, a wire, an electrode, a terminal, a conductive film, etc.) is referred to as being “formed on,” “on,” “connected to,” or “(operatively, functionally, or communicatively) coupled to” another element, layer, region, or component, it can be directly formed on, on, connected to, or coupled to the other element, layer, region, or component, or indirectly formed on, on, connected to, or coupled to the other element, layer, region, or component such that one or more intervening elements, layers, regions, or components may be present. In addition, this may collectively mean a direct or indirect coupling or connection and an integral or non-integral coupling or connection. For example, when a layer, region, or component is referred to as being “electrically connected” or “electrically coupled” to another layer, region, or component, it can be directly electrically connected or coupled to the other layer, region, and/or component or one or more intervening layers, regions, or components may be present. The one or more intervening components may include a switch, a transistor, a resistor, an inductor, a capacitor, a diode and/or the like. Accordingly, a connection is not limited to the connections illustrated in the drawings or the detailed description and may also include other types of connections. In describing embodiments, an expression of connection indicates electrical connection unless explicitly described to be direct connection, and “directly connected/directly coupled,” or “directly on,” refers to one component directly connecting or coupling another component, or being on another component, without an intermediate component.

In addition, in the present specification, when a portion of a layer, a film, an area, a plate, or the like is formed on another portion, a forming direction is not limited to an upper direction but includes forming the portion on a side surface or in a lower direction. On the contrary, when a portion of a layer, a film, an area, a plate, or the like is formed “under” another portion, this includes not only a case where the portion is “directly beneath” another portion but also a case where there is further another portion between the portion and another portion. Meanwhile, other expressions describing relationships between components, such as “between,” “immediately between” or “adjacent to” and “directly adjacent to,” may be construed similarly. It will be understood that when an element or layer is referred to as being “between” two elements or layers, it can be the only element or layer between the two elements or layers, or one or more intervening elements or layers may also be present.

For the purposes of this disclosure, expressions such as “at least one of,” or “any one of,” or “one or more of” when preceding a list of elements, modify the entire list of elements and do not modify the individual elements of the list. For example, “at least one of X, Y, and Z,” “at least one of X, Y, or Z,” “at least one selected from the group consisting of X, Y, and Z,” and “at least one selected from the group consisting of X, Y, or Z” may be construed as X only, Y only, Z only, any combination of two or more of X, Y, and Z, such as, for instance, XYZ, XY, YZ, and XZ, or any variation thereof. Similarly, the expressions “at least one of A and B” and “at least one of A or B” may include A, B, or A and B. As used herein, “or” generally means “and/or,” and the term “and/or” includes any and all combinations of one or more of the associated listed items. For example, the expression “A and/or B” may include A, B, or A and B. Similarly, expressions such as “at least one of,” “a plurality of,” “one of,” and other prepositional phrases, when preceding a list of elements, modify the entire list of elements and do not modify the individual elements of the list. When “C to D” is stated, it means C or more and D or less, unless otherwise specified.

It will be understood that, although the terms “first,” “second,” “third,” etc., may be used herein to describe various elements, components, regions, layers and/or sections, these elements, components, regions, layers and/or sections should not be limited by these terms. These terms do not correspond to a particular order, position, or superiority, and are only used to distinguish one element, member, component, region, area, layer, section, or portion from another element, member, component, region, area, layer, section, or portion. Thus, a first element, component, region, layer, or section described below could be termed a second element, component, region, layer, or section, without departing from the spirit and scope of the present disclosure. The description of an element as a “first” element may not require or imply the presence of a second element or other elements. The terms “first,” “second,” etc. may also be used herein to differentiate different categories or sets of elements. For conciseness, the terms “first,” “second,” etc. may represent “first-category (or first-set),” “second-category (or second-set),” etc., respectively.

In the examples, the x-axis, the y-axis, and/or the z-axis are not limited to three axes of a rectangular coordinate system, and may be interpreted in a broader sense. For example, the x-axis, the y-axis, and the z-axis may be perpendicular to one another, or may represent different directions that are not perpendicular to one another. The same applies for first, second, and/or third directions.

The terminology used herein is for the purpose of describing embodiments only and is not intended to be limiting of the present disclosure. As used herein, the singular forms “a” and “an” are intended to include the plural forms as well, while the plural forms are also intended to include the singular forms, unless the context clearly indicates otherwise. It will be further understood that the terms “comprises,” “comprising,” “have,” “having,” “includes,” and “including,” when used in this specification, specify the presence of the stated features, integers, steps, operations, elements, and/or components, but do not preclude the presence or addition of one or more other features, integers, steps, operations, elements, components, and/or groups thereof.

When one or more embodiments may be implemented differently, a specific process order may be performed differently from the described order. For example, two consecutively described processes may be performed substantially at the same time or performed in an order opposite to the described order.

As used herein, the terms “substantially,” “about,” “approximately,” and similar terms are used as terms of approximation and not as terms of degree, and are intended to account for the inherent deviations in measured or calculated values that would be recognized by those of ordinary skill in the art. For example, “substantially” may include a range of +/−5% of a corresponding value. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value. Further, the use of “may” when describing embodiments of the present disclosure refers to “one or more embodiments of the present disclosure.” Furthermore, the expression “being the same” may mean “being substantially the same.” In other words, the expression “being the same” may include a range that can be tolerated by those of ordinary skill in the art. The other expressions may also be expressions from which “substantially” has been omitted.

In some embodiments well-known structures and devices may be described in the accompanying drawings in relation to one or more functional blocks (e.g., block diagrams), units, and/or modules to avoid unnecessarily obscuring various embodiments. Those skilled in the art will understand that such block, unit, and/or module are/is physically implemented by a logic circuit, an individual component, a microprocessor, a hard wire circuit, a memory element, a line connection, and other electronic circuits. This may be formed using a semiconductor-based manufacturing technique or other manufacturing techniques. The block, unit, and/or module implemented by a microprocessor or other similar hardware may be programmed and controlled using software to perform various functions discussed herein, optionally may be driven by firmware and/or software. In addition, each block, unit, and/or module may be implemented by dedicated hardware, or a combination of dedicated hardware that performs some functions and a processor (for example, one or more programmed microprocessors and related circuits) that performs a function different from those of the dedicated hardware. In addition, in some embodiments, the block, unit, and/or module may be physically separated into two or more interact individual blocks, units, and/or modules without departing from the scope of the present disclosure. In addition, in some embodiments, the block, unit and/or module may be physically combined into more complex blocks, units, and/or modules without departing from the scope of the present disclosure.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

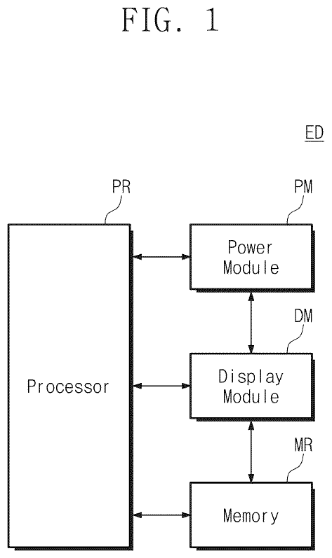

FIG. 1 is a block diagram of an electronic device according to one or more embodiments of the present disclosure.

An electronic device according to the present disclosure may be provided in various forms. The electronic device according to the present disclosure may further include a module or a device having various additional functions.

Referring to FIG. 1, an electronic device ED according to one or more embodiments may include a display module DM, a processor PR, a memory MR, and a power module PM.

The processor PR may include at least one of a central processing unit (CPU), an application processor (AP), a graphic processing unit (GPU), a communication processor (CP), an image signal processor (ISP), or a controller. The processor PR may control the power module PM, the display module DM, and the memory MR.

The memory MR may store data information suitable for the operation of the processor PR or the display module DM. When the processor PR runs the application stored in the memory MR, an image data signal and/or an input control signal may be transmitted to the display module DM, and the display module DM may process the transmitted signal and output the image information through the display screen.

The power module PM may include a power supply module, such as a power adaptor or a battery device, and a power-converting module to convert the power supplied from the power supply module into power suitable for the operation of the electronic device ED.

The display module DM may operate in response to an electrical signal. Some among individual modules functionally included in one module may be included in the display module DM, and other modules among the individual modules may be provided in the electronic device ED, separately from the display module DM.

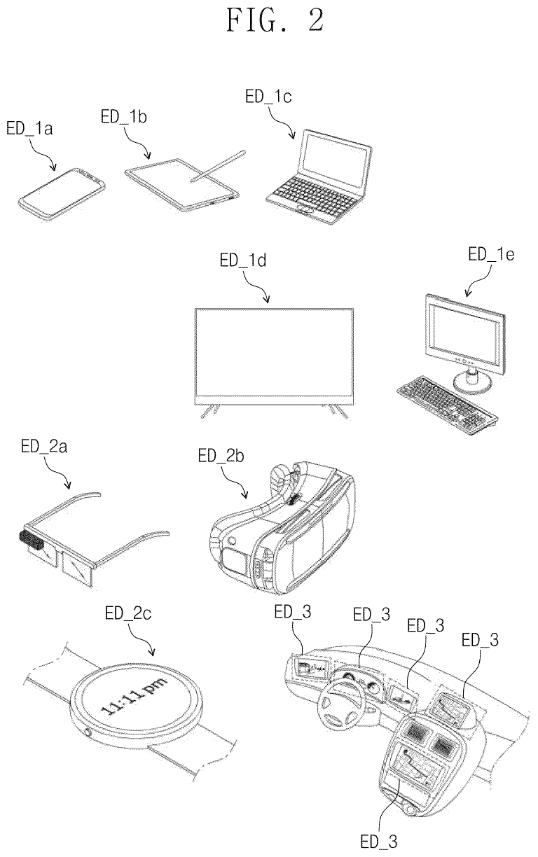

FIG. 2 illustrates schematic views of electronic devices according to various embodiments.

Referring to FIG. 2, the electronic device according to various embodiments may be a wearable electronic device, such as smart glasses ED_2a, a head-mounted display ED_2b, and a smart watch ED_2c, as well as an electronic device for image display, such as a smartphone ED_1a, a tablet PC ED_1b, a laptop computer ED_1c, a television ED_1d, and a desk monitor ED_1e.

In addition, the electronic device according to various embodiments is applied to an interior of a transport device, such as a vehicle to provide, for a user, various pieces of information through an image. For example, a storage device according to the present disclosure may be provided in the form of an electronic device ED-3 for the vehicle including the display module, such as a center information display (CID), which is located in an instrument panel, a center fascia, and a dashboard of a vehicle, or a room mirror display.

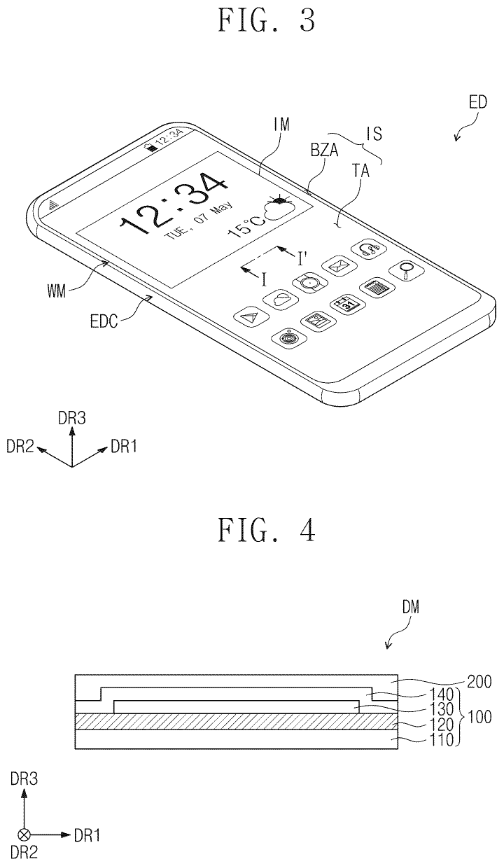

FIG. 3 is a perspective view of an electronic device according to one or more embodiments of the present disclosure, and FIG. 4 is a cross-sectional view of a display module according to one or more embodiments of the present disclosure.

Referring to FIGS. 3 and 4, an electronic device ED according to one or more embodiments of the present disclosure may be in the shape of a rectangle having a short side parallel to a first direction DR1, and a long side parallel to a second direction DR2 crossing the first direction DR1. However, the present disclosure is not limited thereto, and the electronic device ED may have various shapes, such as a circle or a polygon.

The electronic device ED may be a device, which is activated, in response to an electrical signal. The electronic device ED may include various embodiments. For example, the electronic device ED may be applied to an electronic device, such as a smart watch, a tablet personal computer (PC), a laptop computer, a personal computer, or a smart television.

Hereinafter, a direction substantially normal to a plane defined by the first direction DR1 and the second direction DR2 is defined as a third direction DR3. In the specification the meaning of “when viewed in a plan view” may refer to “when viewed in the third direction DR3”.

A top surface of the electronic device ED may be defined as a display surface IS, and may be parallel to a plane defined by the first direction DR1 and the second direction DR2. Images IM generated by the electronic device ED may be provided to a user through the display surface IS.

The display surface IS may be divided into a transmission region TA and a bezel region BZA. The transmission region TA may be a region for displaying the images IM. A user views the images IM through the transmission region TA. According to one or more embodiments, the transmission region TA have vertexes in a rounded-rectangular shape. However, the shape is provided for the illustrative purpose. For example, the transmission region TA may have various shapes, and not limited to any one embodiment.

The bezel region BZA is adjacent to the transmission region TA. The bezel region BZA may have a corresponding color. The bezel region BZA may surround the transmission region TA. Accordingly, the shape of the transmission region TA may be defined substantially by the bezel region BZA. However, this is illustrated for an illustrative purpose. For example, the bezel region BZA may be only located adjacent to one side of the transmission region TA or may be omitted.

The electronic device ED may include a window WM, a display module DM, and a housing EDC. According to one or more embodiments, the window WM is coupled to the housing EDC to form an outer appearance of the electronic device ED.

A front surface of the window WM defines the display surface IS of the electronic device ED. The window WM may include an optically transparent material. For example, the window WM may include glass or plastic. The window WM may include a multi-layer structure or a single-layer structure. For example, the window WM may include a plurality of plastic films bonded by an adhesive or may have a glass substrate and a plastic film bonded by an adhesive.

The housing EDC is coupled to the window WM. The housing EDC is coupled to the window WM to provide a corresponding inner space. The display module DM may be received in the inner space. The housing EDC may include a material having higher rigidity. For example, the housing EDC may include glass, plastic, or metal or may include a plurality of frames and/or a plurality of plates including a combination thereof. The housing EDC may stably protect the components of the electronic device ED, which are received in the inner space, from an external impact. In one or more embodiments, a battery module may be interposed between the display module DM and the housing EDC, to supply a power suitable for the overall operation of the electronic device ED.

The display module DM may include a display layer 100 and a sensor layer 200.

The display layer 100 may be a component that substantially generates an image. The display layer 100 may be a light-emitting display layer. For example, the display layer 100 may be an organic light-emitting display layer, an inorganic light-emitting display layer, an organic-inorganic light-emitting display layer, a quantum dot display layer, a micro-LED display layer, or a nano-LED display layer. The display layer 100 may include a base layer 110, a circuit layer 120, a light-emitting element layer 130, and an encapsulating layer 140.

The base layer 110 may be a member that provides a base surface for placing the circuit layer 120. The base layer 110 may be of a multi-layer structure or a single-layer structure. The base layer 110 may be implemented with a glass substrate, a metal substrate, a silicon substrate, or a polymer substrate, but the present disclosure is not limited thereto.

The circuit layer 120 may be located on the base layer 110 (as used herein, “located on” may mean “above”). The circuit layer 120 may include an insulating layer, a semiconductor pattern, a conductive pattern, and a signal line. The insulating layer, a semiconductor layer, and a conductive layer may be formed on the base layer 110 through a coating or deposition process, and may be selectively patterned through a plurality of photolithography processes.

The light-emitting element layer 130 may be located on the circuit layer 120. The light-emitting element layer 130 may include a light-emitting element. For example, the light-emitting element layer 130 may include an organic light-emitting material, an inorganic light-emitting material, an organic-inorganic light-emitting material, a quantum dot, a quantum rod, a micro-LED, or a nano-LED.

The encapsulating layer 140 may be located on the light-emitting element layer 130. The encapsulating layer 140 may protect the light-emitting element layer 130 from foreign substances, such as moisture, oxygen, and dust particles.

The sensor layer 200 may be located on the display layer 100. The sensor layer 200 may sense an external input applied from the outside. The sensor layer 200 may be an integral type of sensor that is subsequently formed in the manufacturing process for the display layer 100, or may be an external sensor attached to the display layer 100. The sensor layer 200 may be referred to as a “sensor,” an “input-sensing layer,” an “input-sensing panel,” or an “electronic device dedicated to sense input coordinates”.

According to one or more embodiments of the present disclosure, the sensor layer 200 may sense both an input to a passive type input unit, such as a user body and an input into an input device generating a magnetic field of a corresponding resonant frequency. The input device may be referred to as a “pen,” an “input pen,” a “magnetic pen,” a “stylus pen,” or an “electromagnetic resonance pen”.

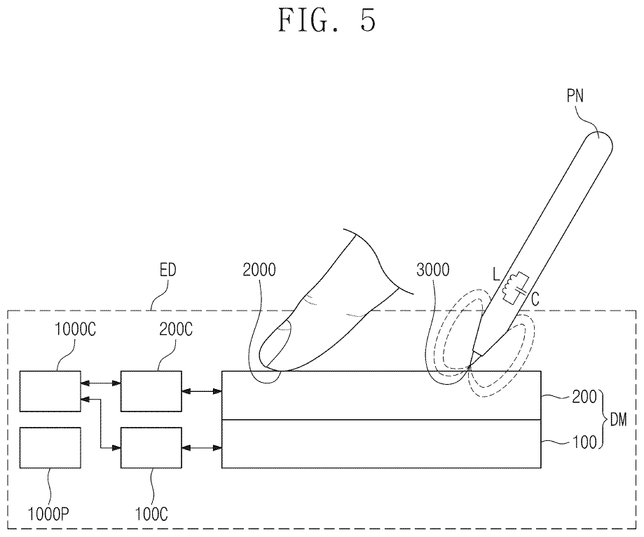

FIG. 5 is a view to describe an operation of an electronic device according to one or more embodiments of the present disclosure.

Referring to FIG. 5, the electronic device ED may include the display layer 100, the sensor layer 200, a display driver 100C, a sensor driver 200C, a main driver 1000C, and a power supply circuit 1000P.

The sensor layer 200 may sense a first input 2000 or a second input 3000 applied thereto from an outside. Each of the first input 2000 and the second input 3000 may be an input by an input unit to make a change in capacitance of the sensor layer 200 or an input unit to induce an induced current to the sensor layer 200. For example, the first input 2000 may be an input by a passive type input unit, such as a user body. The second input 3000 may be an input by the pen PN, or an input by an RFIC tag. For example, the input device PN may be a passive-type pen or an active-type pen. The input device PN may be referred to a pen PN.

According to one or more embodiments of the present disclosure, the input device PN may be a device to generate a magnetic field having a corresponding resonance frequency. The input device PN may be configured to transmit an output signal that is based on an electromagnetic resonance manner. The input device PN may be referred to as an “input device,” an “input pen,” a “magnetic pen,” a “stylus pen,” or an “electromagnetic resonance pen”.

The input device PN may include an RLC resonant circuit, and the RLC resonant circuit may include an inductor “L” and a capacitor “C”. According to one or more embodiments of the present disclosure, the RLC resonance circuit may be a variable resonance circuit to vary a resonance frequency. In this case, the inductor “L” may be a variable inductor, and/or the capacitor “C” may be a variable capacitor. However, the present disclosure is not limited thereto.

The inductor L generates a current by a magnetic field formed in the electronic device ED, for example, the sensor layer 200. However, the present disclosure is not limited thereto. For example, when the input device PN operates in an active type, the input device PN may generate a current even though a magnetic field is not provided from the outside. The generated current is transmitted to the capacitor C. The capacitor C charges the current received from the inductor L, and discharges the charged current to the inductor L. Thereafter, the inductor L may form the magnetic field of the resonant frequency. The induced current may flow in the sensor layer 200 by the magnetic field formed by the input device PN, and the induced current may be transferred to the sensor driver 200C as a receive signal (or a sensing signal or a signal).

The main driver 1000C may control an overall operation of the electronic device ED. For example, the main driver 1000C may control the operations of a display driver 100C and a sensor driver 200C. The main driver 1000C may include at least one microprocessor, and may further include a graphic controller. The main driver 1000C may be referred to as an application processor, a central processing unit, or a main processor.

The display driver 100C may control the display layer 100. The display driver 100C may receive image data and a control signal from the main driver 1000C. The control signal may include various signals. For example, the control signal may include an input vertical synchronization signal, an input horizontal synchronization signal, a main clock signal, and a data enable signal.

The sensor driver 200C may drive the sensor layer 200. The sensor driver 200C may receive a control signal from the main driver 1000C. The control signal may include a clock signal of the sensor driver 200C. In addition, the control signal may further include a mode determining signal for determining a driving mode of the sensor driver 200C and the sensor layer 200.

The sensor driver 200C may be integrated in the form of an integrated circuit (IC) and may be electrically connected to the sensor layer 200. For example, the sensor driver 200C may be directly mounted in a corresponding region of a display panel, or may be mounted on a separate printed circuit board in a chip-on-film; COF) manner to be electrically connected to the sensor layer 200.

The sensor driver 200C and the sensor layer 200 may selectively operate in a first mode or a second mode. For example, the first mode may be a mode for sensing a touch input, such as the first input 2000. The second mode may be a mode for sensing an input, such as the second input 3000, of the input device PN. The first mode may be referred to as a touch-sensing mode, and the second mode may be referred to as a pen-sensing-driving mode.

The switching between the first mode and the second mode may be performed in various switching manners. For example, the sensor driver 200C and the sensor layer 200 may operate in the first mode and the second mode in a time-division manner to sense the first input 2000 and the second input 3000. Alternatively, the switching between the first mode and the second mode may be made by the selection of the user or a corresponding behavior (or input) of the user. Alternatively, any one of the first mode and the second mode may be activated or deactivated, or switched to a remaining mode of the first mode and the second mode through a corresponding application activated or deactivated. Alternatively, the sensor driver 200C and the sensor layer 200 may be maintained in the first mode when sensing the first input 2000 or may be maintained in the second mode when sensing the second input 3000, while alternatively operating in the first mode and the second mode.

The sensor driver 200C may calculate information on coordinates of an input, based on a signal received from the sensor layer 200, and may provide a coordinate signal having the coordinate information to the main driver 1000C. The main driver 1000C executes an operation corresponding to the user input, in response to the coordinate signal. For example, the main driver 1000C may operate the display driver 100C such that a new application image is displayed on the display layer 100.

The power supply circuit 1000P may include a power management integrated circuit (PMIC). The power supply circuit 1000P may generate a plurality of driving voltages to drive the display layer 100, the sensor layer 200, the display driver 100C, and the sensor driver 200C. For example, the plurality of driving voltages may include a high gate voltage, a low gate voltage, a first driving voltage (e.g., an ELVSS voltage), a second driving voltage (e.g., an ELVDD voltage), an initialization voltage, but the present disclosure is not limited thereto.

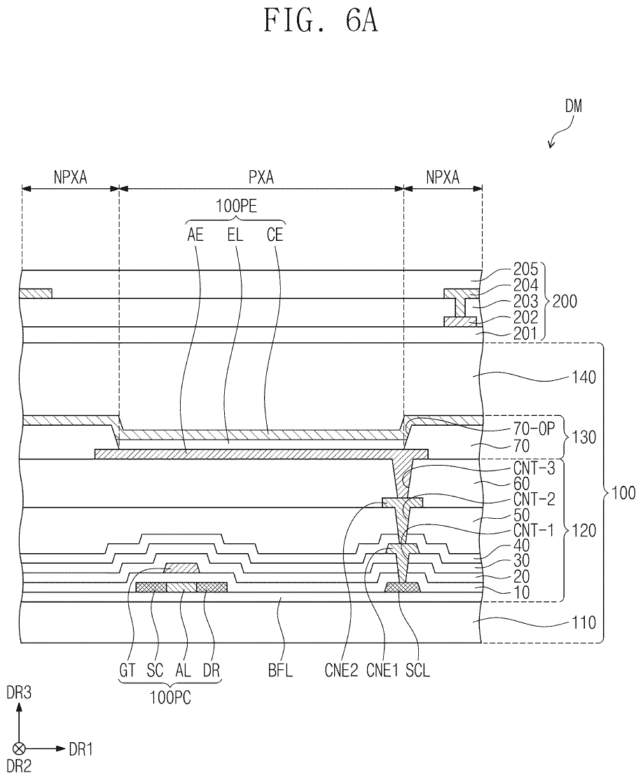

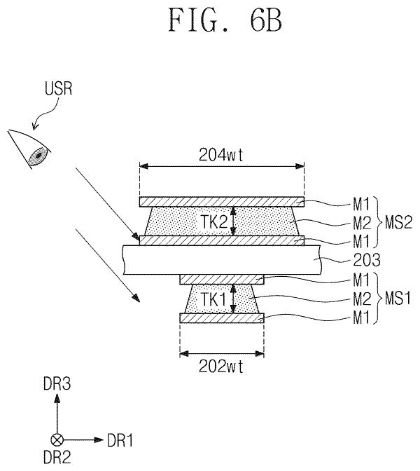

FIG. 6A is a cross-sectional view of a display module according to one or more embodiments of the present disclosure. In the following description made with reference to FIG. 6A, the components that have been described with reference to FIG. 4 will be assigned with the same reference numerals, and the details thereof will be omitted.

Referring to FIG. 6A, at least one buffer layer BFL is formed on a top surface of the base layer 110. The buffer layer BFL may improve a bonding force between the base layer 110 and the semiconductor pattern. The buffer layer BFL may be formed in a multi-layer structure. Alternatively, the display layer 100 may further include a barrier layer. The buffer layer BFL may include at least one of silicon oxide, silicon nitride, or silicon oxynitride. For example, the buffer layer BFL may include a structure in which a silicon oxide layer and a silicon nitride layer are stacked alternately.

A semiconductor pattern (SC, AL, DR, and SCL) may be located on the buffer layer BFL. The semiconductor pattern (SC, AL, DR, and SCL) may include polysilicon. However, the present disclosure is not limited thereto. For example, the semiconductor pattern (SC, AL, DR, and SCL) may include amorphous silicon, low-temperature polycrystalline silicon, or oxide semiconductor.

FIG. 6A illustrates merely a portion of the semiconductor pattern (SC, AL, DR, and SCL), and the semiconductor pattern (SC, AL, DR, and SCL) may be further located in another region. The semiconductor patterns (SC, AL, DR, and SCL) may be arranged across pixels in compliance with a corresponding rule. The electrical property of the semiconductor pattern (SC, AL, DR, and SCL) may be differently determined depending on whether the semiconductor pattern (SC, AL, DR, and SCL) is doped. The semiconductor pattern (SC, AL, DR, and SCL) may include a first region (SC, DR, and SCL) having higher conductivity and a second region AL having lower conductivity. The first region (SC, DR, and SCL) may be doped with an N-type dopant or a P-type dopant. A P-type transistor may include a doping region doped with the P-type dopant, and an N-type transistor may include a doping region doped with the N-type dopant. The second region AL may be a non-doping region or a region doped at a concentration lower than a concentration of the first region (SC, DR, and SCL).

The conductivity of the first region (SC, DR, and SCL) may be greater than the conductivity of the second region AL and may substantially serve as an electrode or a signal line. The second region AL may substantially correspond to an active region AL (or a channel) of a transistor 100PC. In other words, a portion AL of the semiconductor pattern (SC, AL, DR, and SCL) may be an active region AL of the transistor 100PC, another portion (SC, DR) thereof of the transistor 100PC may be a source region SC or a drain region DR of the transistor 100PC, and a still another portion SCL of the transistor 100PC may be a connection electrode or a connection signal line SCL.

Each of pixels may have an equivalent circuit including a plurality of transistors, at least one capacitor, and at least one light-emitting element, and the equivalent circuit of the pixel may be modified in various forms. FIG. 6A illustrates that the pixel includes one transistor 100PC and one light-emitting element 100PE, which are included in the pixel.

The source region SC, the active region AL, and the drain region DR of the transistor 100PC may be formed from the semiconductor pattern (SC, AL, DR, and SCL). The source region SC and the drain region DR may extend in directions opposite to each other from the active region AL when viewed in a cross-sectional view. A portion of the connection signal line SCL formed from the semiconductor pattern (SC, AL, DR, and SCL) is illustrated in FIG. 6A. In one or more embodiments, the connection signal line SCL may be connected to the drain region DR of the transistor 100PC when viewed in a plan view.

A first insulating layer 10 may be located on the buffer layer BFL. The first insulating layer 10 may overlap a plurality of pixels in common to cover the semiconductor pattern (SC, AL, DR, and SCL). The first insulating layer 10 may be an inorganic layer and/or an organic layer and may have a single-layer or multi-layer structure. The first insulating layer 10 may include at least one of an aluminum oxide, a titanium oxide, a silicon oxide, a silicon nitride, a silicon oxynitride, a zirconium oxide, or hafnium oxide. According to one or more embodiments, the first insulating layer 10 may be a single silicon oxide layer. The insulating layer of the circuit layer 120, which is to be described below, in addition to the first insulating layer 10, may be an inorganic layer and/or an organic layer, and may have a single-layer structure or a multi-layer structure. The inorganic layer may include at least one of the materials described above but is not limited thereto.

A gate GT of the transistor 100PC is located on the first insulating layer 10. The gate GT may be a portion of a metal pattern. The gate GT overlaps the active region AL. The gate GT may function as a mask in the process of doping or reducing the semiconductor pattern (SC, AL, DR, and SCL).

A second insulating layer 20 may be located on the first insulating layer 10 to cover the gate GT. The second insulating layer 20 may be commonly overlapped in the pixels. The second insulating layer 20 may be an inorganic layer and/or an organic layer, and may have a single-layer structure or a multi-layer structure. The second insulating layer 20 may include at least one of silicon oxide, silicon nitride, or silicon oxynitride. According to one or more embodiments, the second insulating layer 20 may have a multi-layer structure including a silicon oxide layer and a silicon nitride layer.

A third insulating layer 30 may be located on the second insulating layer 20. The third insulating layer 30 may have a single-layer structure or a multi-layer structure. For example, the third insulating layer 30 may have a multi-layer structure including a silicon oxide layer and a silicon nitride layer.

A first connection electrode CNE1 may be located on the third insulating layer 30. The first connection electrode CNE1 may be connected to a connection signal line SCL through a contact hole CNT-1 formed through the first, second, and third insulating layers 10, 20, and 30.

A fourth insulating layer 40 may be located on the third insulating layer 30. The fourth insulating layer 40 may be a single silicon oxide layer. A fifth insulating layer 50 may be located on the fourth insulating layer 40. The fifth insulating layer 50 may be an organic layer.

A second connection electrode CNE2 may be located on the fifth insulating layer 50. The second connection electrode CNE2 may be connected to the first connection electrode CNE1 through a contact hole CNT-2 formed through the fourth insulating layer 40, and the fifth insulating layer 50.

A sixth insulating layer 60 may be located on the fifth insulating layer 50 to cover the second connection electrode CNE2. The sixth insulating layer 60 may be an organic layer.

The light-emitting element layer 130 may be located on the circuit layer 120. The light-emitting element layer 130 may include a light-emitting element 100PE. For example, the light-emitting element layer 130 may include an organic light-emitting material, an inorganic light-emitting material, an organic-inorganic light-emitting material, a quantum dot, a quantum rod, a micro-LED, or a nano-LED. The following description will be described while focusing on that the light-emitting element 100PE is an organic light-emitting element, but the present disclosure is not specifically limited thereto.

The light-emitting element 100PE may include a first electrode AE, a light-emitting layer EL, and a second electrode CE.

The first electrode AE may be located on the sixth insulating layer 60. The first electrode AE may be connected to the second connection electrode CNE2 through a contact hole CNT-3 formed through the sixth insulating layer 60.

A pixel-defining layer 70 may be located on the sixth insulating layer 60 to cover a portion of the first electrode AE. An opening 70-OP is defined in the pixel-defining layer 70. The opening 70-OP of the pixel-defining layer 70 exposes at least a portion of the first electrode AE.

The transmission region TA (refer to FIG. 3) may include an emission region PXA and a non-emission region NPXA adjacent to the emission region PXA. The non-emission region NPXA may surround the emission region PXA. According to one or more embodiments, the emission region PXA is defined to correspond to a portion of the first electrode AE that is exposed by the opening 70-OP.

The light-emitting layer EL may be located on the first electrode AE. The light-emitting layer EL may be located in the area defined by the opening 70-OP. Although FIG. 6A illustrates that the light-emitting layer EL is located in the opening 70-OP, the present disclosure is not limited thereto. For example, the light-emitting layer EL may extend to cover a portion of a side surface of the pixel-defining layer 70 and the top surface of the pixel-defining layer 70, which define the opening 70-OP.

According to one or more embodiments of the present disclosure, the light-emitting layer EL may be separately formed with respect to each of pixels. When the light-emitting layer EL is independently formed with respect to each of the pixels, each of light-emitting layers EL may emit a light having at least one of a blue color, a red color, or a green color. However, the present disclosure is not limited thereto. The light-emitting layer EL may have an integral form, and may be included in the plurality of pixels in common. In this case, the light-emitting layer EL may provide a blue color or may provide a white color.

The second electrode CE may be located on the light-emitting layer EL. The second electrode CE may have an integral form and may be included in a plurality of pixels in common.

According to one or more embodiments of the present disclosure, a hole control layer may be interposed between the first electrode AE and the light-emitting layer EL. The hole control layer may be located in common in the emission region PXA and the non-emission region NPXA. The hole control layer may include a hole transport layer, and may further include a hole injection layer. An electron control layer may be located between the light-emitting layer EL and the second electrode CE. The electron control layer may include an electron transport layer and may further include an electron injection layer. The hole control layer and the electron control layer may be formed in the plurality of pixels in common by using an open mask or an ink-jet process.

The encapsulating layer 140 may be located on the light-emitting element layer 130. The encapsulating layer 140 may include an inorganic layer, an organic layer, and an inorganic layer sequentially stacked, and layers for forming the encapsulating layer 140 are not limited thereto. The inorganic layers may protect the light-emitting element layer 130 from moisture and oxygen, and the organic layer may protect the light-emitting element layer 130 from a foreign material, such as dust particles. The inorganic layers may include a silicon nitride layer, a silicon oxynitride layer, a silicon oxide layer, a titanium oxide layer, or an aluminum oxide layer. The organic layer may include an acrylic-based organic layer, but the present disclosure is not limited thereto.

The sensor layer 200 may include a base layer 201, a first conductive layer 202, an intermediate insulating layer 203, a second conductive layer 204, and a cover insulating layer 205.

The base layer 201 may be an inorganic layer including at least one of silicon nitride, silicon oxynitride, or silicon oxide. Alternatively, the base layer 201 may be an organic layer including an epoxy resin, an acrylic resin, or an imide-based resin. The base layer 201 may have a single-layer structure or a multi-layer structure including layers stacked in the third direction DR3. According to one or more embodiments of the present disclosure, the sensor layer 200 may not include the base layer 201.

Each of the first conductive layer 202 and the second conductive layer 204 may have a single-layer structure or a multi-layer structure including the layers stacked in the third direction DR3.

Each of the first conductive layer 202 and the second conductive layer 204 having a single-layer structure may include a metal layer or a transparent conductive layer. The metal layer may include molybdenum, silver, titanium, copper, aluminum, or alloy thereof. The transparent conductive layer may include a transparent conductive oxide, such as indium tin oxide (ITO), indium zinc oxide (IZO), zinc oxide (ZnO), or indium zinc tin oxide (IZTO). In addition, the transparent conductive layer may include conductive polymer, such as poly(3,4-ethylenedioxythiophene) (PEDOT), metal nanowire, or graphene.

Each of the first conductive layer 202 and the second conductive layer 204 having a multi-layer structure may include metal layers. The metal layers may have, for example, a three-layer structure of titanium/aluminum/titanium. The conductive layer in the multi-layer structure may include at least one metal layer and at least one transparent conductive layer.

According to one or more embodiments of the present disclosure, the thickness of the first conductive layer 202 may be greater than or equal to the thickness of the second conductive layer 204. When the thickness of the first conductive layer 202 is greater than the thickness of the second conductive layer 204, the resistance of components (e.g., an electrode, a pattern, or a bridge pattern) included in the first conductive layer 202 may be reduced. In addition, because the first conductive layer 202 is located below the second conductive layer 204, even if the thickness of the first conductive layer 202 is increased, the probability that components included in the first conductive layer 202 are viewed by external light reflection may be lower than that of the second conductive layer 204.

At least one of the intermediate insulating layer 203 and the cover insulating layer 205 may include an inorganic film. The inorganic film may include at least one of an aluminum oxide, a titanium oxide, a silicon oxide, a silicon nitride, a silicon oxynitride, a zirconium oxide, or hafnium oxide.

At least one of the intermediate insulating layer 203 or the cover insulating layer 205 may include an organic film. The organic film may include at least one of an acrylic resin, a methacryl resin, polyisoprene, a vinyl resin, an epoxy resin, a urethane resin, a cellulose resin, a siloxane resin, a polyimide resin, a polyamide resin, or a perylene resin.

Although the above-description has been made regarding that the sensor layer 200 includes the total of two conductive layers of the first conductive layer 202 and the second conductive layer 204, the present disclosure is not limited thereto. For example, the sensor layer 200 may include at least three conductive layers.

FIG. 6A is a cross-sectional view illustrating some components of a sensor layer according to one or more embodiments of the present disclosure.

Referring to FIGS. 6A and 6B, a second width 204wt of a second mesh line MS2 included in the second conductive layer 204 may be equal to or greater than a first width 202wt of a first mesh line MS1 included in the first conductive layer 202. When a user USR views the first mesh line MS1 and the second mesh line MS2 from the side, because the first mesh line MS1 has a smaller width than the width of the second mesh line MS2, the probability that the first mesh line MS1 is viewed by the user USR may be reduced.

Each of the first mesh line MS1 and the second mesh line MS2 may include first metal layers M1 and a second metal layer M2 interposed between the first metal layers M1. For example, the first metal layers M1 may include titanium (Ti), and the second metal layer M2 may include aluminum (Al). However, the present disclosure is not specifically limited.

According to one or more embodiments of the present disclosure, a first thickness TK1 of the second metal layer M2 of the first mesh line MS1 may be substantially equal to a second thickness TK2 of the second metal layer M2 of the second mesh line MS2, but the present disclosure is not particularly limited thereto. For example, the first thickness TK1 may be thicker than the second thickness TK2. Alternatively, the second thickness TK2 may be thicker than the first thickness TK1. According to one or more embodiments of the present disclosure, each of the first thickness TK1 and the second thickness TK2 may be 1000 angstroms or more, for example, 6000 angstroms.

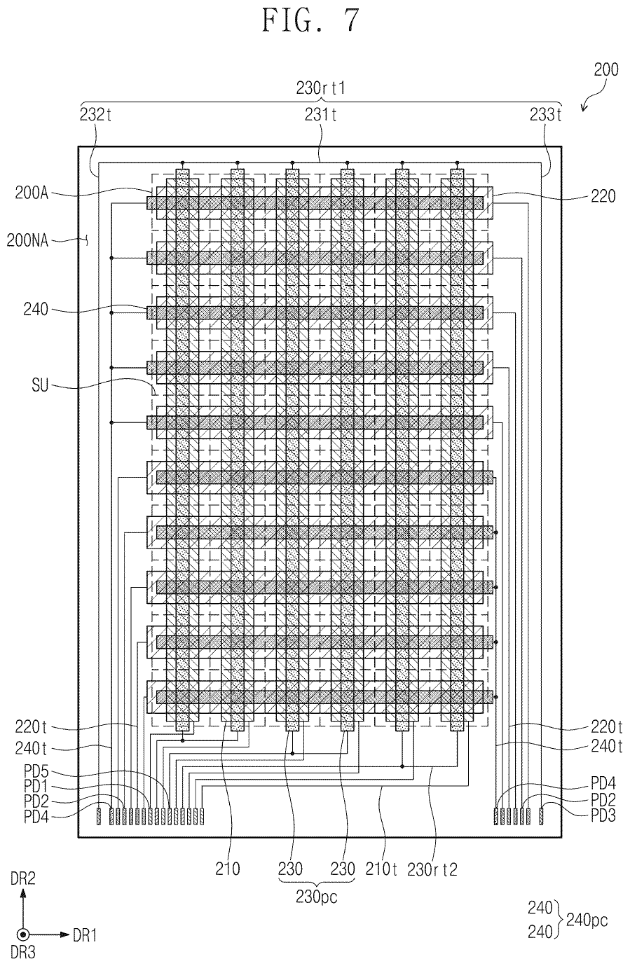

FIG. 7 is a plan view illustrating a sensor layer according to one or more embodiments of the present disclosure.

Referring to FIG. 7, the sensor layer 200 may include a sensing region 200A and a peripheral region 200NA adjacent to the sensing region 200A.

The sensor layer 200 may include a plurality of first electrodes 210, a plurality of second electrodes 220, a plurality of third electrodes 230, and a plurality of fourth electrodes 240, which are located in the sensing region 200A.

Each of the plurality of first electrodes 210 may cross the plurality of second electrodes 220. Each of the plurality of first electrodes 210 may extend in the second direction DR2, and the plurality of first electrodes 210 may be arranged to be spaced from each other in the first direction DR1. Each of the plurality of second electrodes 220 may extend in the first direction DR1, and the plurality of second electrodes 220 may be arranged to be spaced from each other in the second direction DR2. A sensing unit SU of the sensor layer 200 may be a region in which one first electrode 210 and one second electrode 220 cross each other.

Although FIG. 7 illustrates that six first electrodes 210 and ten second electrodes 220 (e.g., sixty sensing units SU), the number of the first electrodes 210 and the number of the second electrodes 220 are not limited thereto.

Each of the plurality of third electrodes 230 may extend in the second direction DR2, and the plurality of third electrodes 230 may be arranged to be spaced from each other in the first direction DR1. One third electrode 230 may be at least partially overlapped with one first electrode 210. According to one or more embodiments of the present disclosure, the capacitance (or coupling capacitance) between the one first electrode 210 and the one third electrode 230 may be adjusted by adjusting the overlap area between the one first electrode 210 and the one third electrode 230. A plurality of third electrodes 230 may be insulated from a plurality of second electrodes 220.

According to one or more embodiments of the present disclosure, at least some of the plurality of third electrodes 230 may be connected in parallel to each other. For example, although FIG. 7 illustrates that two third electrodes 230 are connected in parallel to each other to constitute a first electrode group 230pc, three first electrode groups 230pc may be arranged in the first direction DR1. However, the number of third electrodes 230 for forming the first electrode group 230pc is not limited thereto. For example, one first electrode group 230pc may include only one third electrode 230, or may include three or more third electrodes 230.

As the number of third electrodes 230 included in the first electrode group 230pc and connected to each other in parallel increases, the resistance of the first electrode group 230pc may decrease, such that power efficiency is improved and sensing sensitivity is enhanced. To the contrary, as the number of third electrodes 230 included in the first electrode group 230pc decreases, a loop coil pattern formed by using the first electrode group 230pc may be implemented in more various forms.

Each of the plurality of fourth electrodes 240 may be arranged in the second direction DR2, and the plurality of fourth electrodes 240 may extend in the first direction DR1. One fourth electrode 240 may be at least partially overlapped with one second electrode 220. According to one or more embodiments of the present disclosure, the capacitance (or coupling capacitance) between the one second electrode 220 and the one fourth electrode 240 may be adjusted by adjusting the overlap area between the one second electrode 220 and the one fourth electrode 240.

According to one or more embodiments of the present disclosure, at least some of the plurality of fourth electrodes 240 may be electrically connected to each other to form one second electrode group 240pc. For example, FIG. 7 illustrates that five fourth electrodes 240 are connected to an identical/common trace line, which is fourth trace line 240t, to form one second electrode group 240pc. Accordingly, FIG. 7 illustrates two second electrode groups 240pc arranged in the second direction DR2. However, the number of fourth electrodes 240 constituting one second electrode group 240pc is not limited thereto. For example, the number of fourth electrodes 240 form forming one second electrode group 240pc may be ten. In this case, the sensor layer 200 may include only one second electrode group 240pc.

According to one or more embodiments of the present disclosure, the sensor layer 200 may further include a plurality of first trace lines 210t located in a peripheral region 200NA, a plurality of first pads PD1 connected in a one-to-one correspondence to the first trace lines 210t, a plurality of second trace lines 220t, and a plurality of second pads PD2 connected in a one-to-one correspondence to the second trace lines 220t, in the peripheral region 200NA. The first trace lines 210t may be electrically connected in a one-to-one correspondence to the first electrodes 210. The second trace lines 220t may be electrically connected in a one-to-one correspondence to the second electrodes 220.

The sensor layer 200 may further include a third trace line 230rt1 located in the peripheral region 200NA, a plurality of third pads PD3 connected to one end of the third trace line 230rt1 and to an opposite end of the third trace line 230rt1, fourth trace lines 240t, fourth pads PD4 connected in a one-to-one correspondence to the fourth trace lines 240t, fifth trace lines 230rt2, and fifth pads PD5 connected in a one-to-one correspondence to the fifth trace lines 230rt2.

The third trace line 230rt1 may be electrically connected to a plurality of third electrodes 230. According to one or more embodiments of the present disclosure, the third trace line 230rt1 may be electrically connected to all of the plurality of third electrodes 230. The third trace line 230rt1 may include the first line part 231t, which extends in the first direction DR1 and is electrically connected to the plurality of third electrodes 230, a second line part 232t, which extends in the second direction DR2 from a first end portion of the first line part 231t, and a third line part 233t that extends in the second direction DR2 from a second end portion of the first line part 231t.

According to one or more embodiments of the present disclosure, a resistance of the second line part 232t and a resistance of the third line part 233t may each be substantially equal to a resistance of one of the plurality of third electrodes 230. Accordingly, the second line part 232t and the third line part 233t may function as the plurality of third electrodes 230, which may function as when the third electrodes 230 are located in the peripheral region 200NA. For example, any one of the second line part 232t and the third line part 233t, and one of the third electrodes 230, may form a coil. Accordingly, even a pen positioned in a region adjacent to the peripheral region 200NA may be sufficiently charged by a loop including the second line part 232t or the third line part 233t.

According to one or more embodiments of the present disclosure, to adjust the resistance of the second line part 232t and the resistance of the third line part 233t, a width of each of the second line part 232t and the third line part 233t in the first direction DR1 may be adjusted. However, this is provided only for illustrative purpose. For example, the first to third line parts 231t, 232t, and 233t may have substantially the same width.

The plurality of fifth trace lines 230rt2 may be connected in a one-to-one correspondence to the first electrode groups 230pc, respectively. In other words, the number of the plurality of fifth trace lines 230rt2 may correspond to the number of the plurality of first electrode groups 230pc. FIG. 7 illustrates three fifth trace lines 230rt2 and three first electrode groups 230pc.

According to one or more embodiments of the present disclosure, the plurality of fifth trace lines 230rt2 and the plurality of fifth pads PD5 may be omitted, and a charging-driving mode for charging the pen may be omitted. In this case, the sensor layer 200 may sense the input by the active-type pen, which is able to emit a magnetic field, even if a magnetic field is not provided from the sensor layer 200.

According to one or more embodiments of the present disclosure, the plurality of fourth trace lines 240t may be spaced apart from each other while interposing the sensing region 200A between the fourth trace lines 240t. The plurality of fourth trace lines 240t may be electrically connected in a one-to-one correspondence to the plurality of second electrode groups 240pc. FIG. 7 illustrates that two second electrode groups 240pc are arranged. The fourth trace line 240t connected to one second electrode group 240pc, and the fourth trace line 240t connected to another second electrode group 240pc, may be spaced apart from each other while interposing the sensing region 200A positioned between the fourth trace line 240t connected to the one second electrode group 240pc and the fourth trace line 240t connected to the another second electrode group 240pc. However, the present disclosure is not limited thereto.

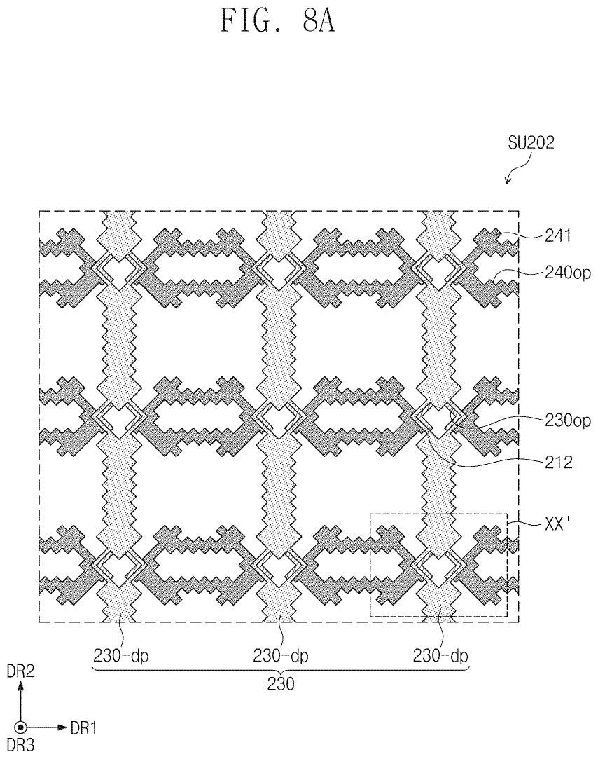

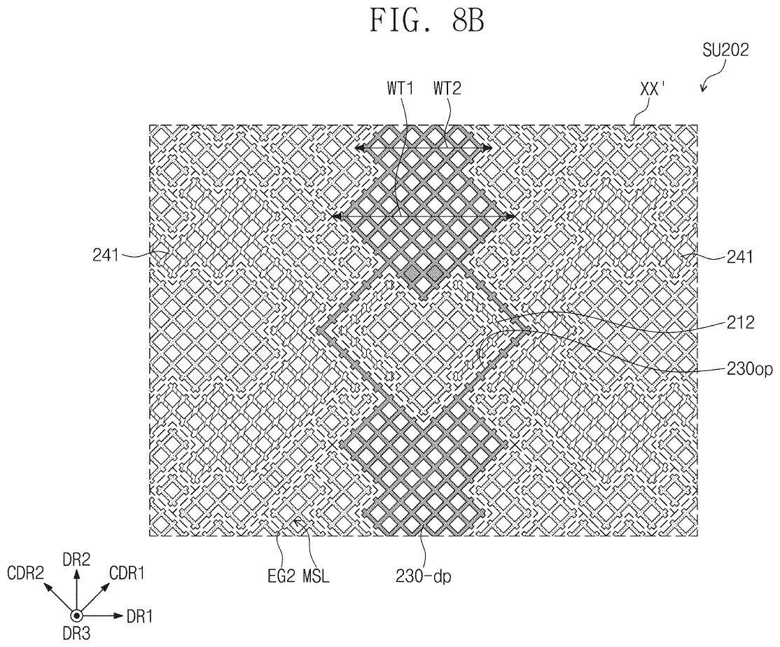

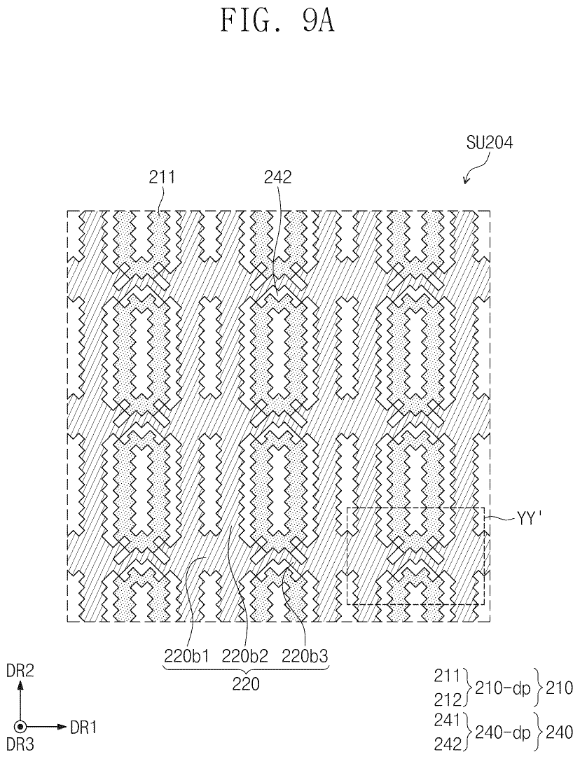

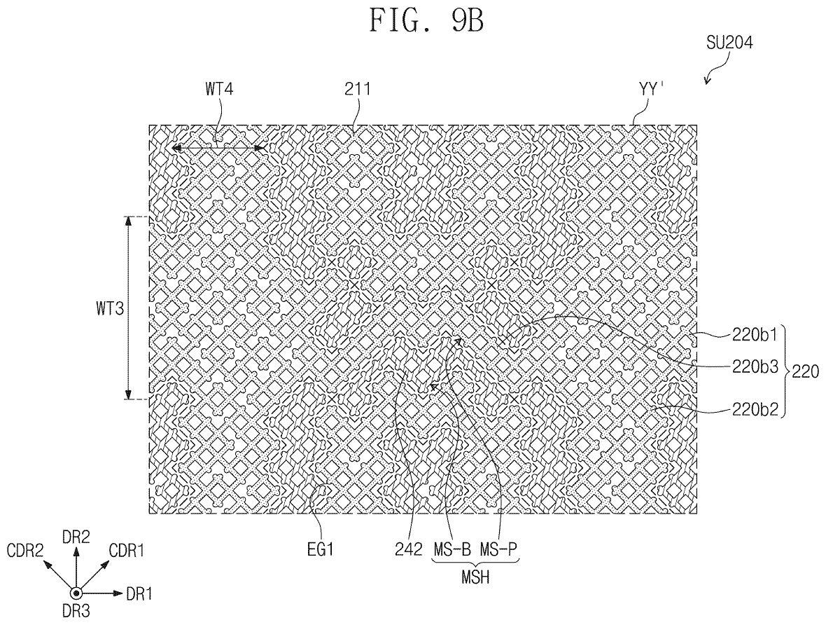

FIG. 8A is a plan view illustrating a first conductive layer of a sensing unit according to one or more embodiments of the present disclosure, and FIG. 8B is an enlarged plan view of an XX′ region illustrated in FIG. 8A according to one or more embodiments of the present disclosure. FIG. 9A is a plan view illustrating a second conductive layer of a sensing unit according to one or more embodiments of the present disclosure, and FIG. 9B is an enlarged plan view of a YY′ region illustrated in FIG. 9A according to one or more embodiments of the present disclosure.

In FIGS. 9A and 9B, the boundaries of each component are briefly illustrated as lines without depicting the mesh structure shape. In other words, the lines illustrated in FIGS. 8A and 9A may be understood as corresponding to cutting lines of the mesh structures illustrated in FIGS. 8B and 9B. In FIGS. 8B and 9B, the cutting lines are illustrated as dotted lines.

The shape of the sensing unit SU illustrated in FIGS. 7, 8A, 8B, 9A, and 9B is provided only for the illustrative purpose, but the present disclosure is not limited thereto. The shape of the sensing unit SU may be variously modified.

Referring to FIGS. 7, 8A, 8B, 9A, and 9B, the first electrode 210 may include a plurality of first divided electrodes 210-dp spaced apart from each other in the first direction DR1. Each of the plurality of first divided electrodes 210-dp may include a plurality of first patterns 211, and a plurality of first bridge patterns 212 electrically connected to the plurality of first patterns 211. The plurality of first patterns 211, which are arranged to be spaced apart from each other in the second direction DR2, may be electrically connected to each other by the plurality of first bridge patterns 212. Accordingly, each of the plurality of first divided electrodes 210-dp may extend in the second direction DR2, and the plurality of first divided electrodes 210-dp may be spaced apart from each other in the first direction DR1.

The third electrode 230 may include a plurality of second divided electrodes 230-dp spaced apart from each other in the first direction DR1. Each of the plurality of second divided electrodes 230-dp may extend in the second direction DR2. The plurality of second divided electrodes 230-dp may be spaced apart from each other in the first direction DR1.

When viewed in the third direction DR3, the plurality of second divided electrodes 230-dp may overlap the plurality of first divided electrodes 210-dp in a one-to-one correspondence. The term “overlapped with” or “overlap” may also include a case that at least a portion of one first divided electrode 210-dp overlap at least a portion of one second divided electrode 230-dp.

FIGS. 8A and 9A illustrate three first divided electrodes 210-dp and three second divided electrodes 230-dp included in one sensing unit SU, but the present disclosure is not particularly limited thereto. For example, the number of the first divided electrodes 210-dp and the number of the second divided electrodes 230-dp included in one sensing unit SU may each be one, two, or four or more. Each of the plurality of first divided electrodes 210-dp and each of the plurality of second divided electrodes 230-dp may correspond to a signal transmission path or a resistance path for transmitting a signal.

Referring to FIGS. 7 and 8A, one fifth trace line 230rt2 may be electrically connected to one first electrode group 230pc. One first electrode group 230pc may include two third electrodes 230. In this case, one fifth trace line 230rt2 may be electrically connected to six second divided electrodes 230-dp. In this case, a degree of increase in the number of pads in the sensor layer 200 may be reduced.

As compared to a case that the first electrode 210 is not divided and has a single shape within one sensing unit SU, when the first electrode 210 includes the plurality of first divided electrodes 210-dp within one sensing unit SU, the plurality of first divided electrodes 210-dp may be arranged with relatively uniform distribution within the sensing unit SU. In this case, a signal may be uniformly provided or sensed within the sensing unit SU.

As compared to a case that the first electrode 210 is not divided within one sensing unit SU, when the first electrode 210 includes the plurality of first divided electrodes 210-dp within one sensing unit SU, the number of the plurality of first bridge patterns 212 may increase within the sensing unit SU. In FIG. 8A, on the assumption that two first bridge patterns 212 connected to the same two first patterns 211 are viewed as one pair, nine pairs of first bridge patterns 212 are illustrated. In other words, eighteen first bridge patterns 212 are illustrated in total.

According to the present disclosure, the increase in the number of the plurality of first bridge patterns 212 arranged in the first direction DR1 crossing the second direction DR2, which is an extending direction of the first electrode 210, may correspond to an increase in signal paths. Accordingly, as the number of signal paths increases, the resistance of the first electrode 210 may be reduced. Accordingly, the sensing sensitivity of the sensor layer 200 may be improved.

According to the present disclosure, each shape of the plurality of first divided electrodes 210-dp may approximate a bar shape extending in the second direction DR2. As the shape of the plurality of first divided electrodes 210-dp approximates the bar shape, a resistance path length may be shortened. Accordingly, when the resistance path length is shortened, and when the number of resistance paths connected in parallel to each other within the first electrode 210 increases, the resistance of the first electrode 210 may be reduced. Accordingly, the sensing sensitivity of the sensor layer 200 may be improved.

In addition, according to the present disclosure, as each shape of the plurality of first divided electrodes 210-dp approximates a bar shape extending in the second direction DR2, a ratio of an area available for pattern design within a total area of one sensing unit SU may increase. Accordingly, a degree of freedom in pattern design may be improved.

According to one or more embodiments of the present disclosure, a degree of freedom in pattern design of the sensing unit SU may be improved, and a resistance of an electrode included in the sensing unit SU may be reduced. In this case, a frequency range (for example, bandwidth) applicable to a signal provided to the sensor layer 200 may be more advantageously ensured. Accordingly, a degree of freedom in pattern design may be improved.

According to one or more embodiments of the present disclosure, each of the plurality of first patterns 211 may have a ring shape, and an overlap part between each of the plurality of second divided electrodes 230-dp and each of the plurality of first patterns 211 may approximate a bar shape. In this case, an overlap area between the first electrode 210 and the third electrode 230 may be suitably adjusted by adjusting an inner diameter size of each of the plurality of first patterns 211 or by adjusting a width of each of the plurality of second divided electrodes 230-dp.

According to one or more embodiments of the present disclosure, the first divided electrode 210-dp may include the plurality of first patterns 211 and the plurality of first bridge patterns 212 located in different layers, and the plurality of first patterns 211 and the plurality of first bridge patterns 212 may be electrically connected to each other through contacts. In this case, as compared to when the plurality of first patterns 211 and the plurality of first bridge patterns 212 are located in the same layer and integrally provided, a resistance may be relatively increased.

According to one or more embodiments of the present disclosure, the resistance of a portion of the second divided electrode 230-dp overlapped with the first pattern 211 may be lower than the resistance of the first pattern 211. However, this is provided only for the illustrative purpose. The resistance relationship may be changed depending on a size of a width of a ring of the first pattern 211 or depending on a size of a width of a portion of the second divided electrode 230-dp.

The second divided electrode 230-dp may extend in the second direction DR2 within the same layer. Accordingly, an increase in resistance due to layer changes may not occur, within the second divided electrode 230-dp. The second divided electrode 230-dp may be an electrode to which a signal is applied in a charging-driving mode to be described later. Accordingly, as the resistance of the second divided electrode 230-dp becomes lower, the intensity of a current and a magnetic field for charging a resonant circuit of the input device PN (refer to FIG. 5) may become stronger.

According to one or more embodiments of the present disclosure, because the overlap portion between each of the plurality of second divided electrodes 230-dp and the plurality of first patterns 211 approximates a bar shape, each of the second divided electrodes 230-dp may have a width that is narrower than a width of the first divided electrodes 210-dp. In this case, a parasitic capacitance generated in each of the second divided electrodes 230-dp may be reduced. Accordingly, the sensing sensitivity of the sensor layer 200 may be improved.

Referring to FIG. 8B, the second divided electrode 230-dp may include a first part having a first width WT1 in the first direction DR1, and a second part having a second width WT2 in the second direction DR2. The first width WT1 may be greater than the second width WT2. For example, the first part having the first width WT1 may be positioned closer to the first bridge patterns 212, as compared to the second part having the second width WT2.

The first part having the first width WT1 may overlap the plurality of first patterns 211 to form capacitance, when viewed in a plan view. In addition, the second part having the second width WT2 may overlap a dummy pattern surrounded by the first patterns 211. An overlap area between the first electrode 210 and the third electrode 230 may be suitably adjusted by adjusting the second width WT2.

An opening 230op may be defined in the second divided electrode 230-dp, and two first bridge patterns 212 may be located within the opening 230op. When the plurality of first bridge patterns 212 are surrounded by the second divided electrode 230-dp, capacitances, which have values varied depending on temperature, may be reduced among capacitances generated in the first electrode 210. Accordingly, the temperature characteristic of the sensor layer 200 may be improved.

The second electrode 220 may include a plurality of first branch parts 220b1 extending in the first direction DR1, a plurality of second branch parts 220b2 extending in the second direction DR2 crossing the first direction DR1, and a connection part 220b3 located between the first patterns 211. The plurality of first branch parts 220b1 may be spaced apart from each other in the second direction DR2, and the plurality of second branch parts 220b2 may be spaced apart in the first direction DR1. The plurality of first branch parts 220b1, the plurality of second branch parts 220b2, and the connection part 220b3 may be connected to each other to form an integral form

The fourth electrode 240 may include a plurality of third divided electrodes 240-dp spaced apart from each other in the second direction DR2. Each of the plurality of third divided electrodes 240-dp may extend in the first direction DR1. Each of the plurality of third divided electrodes 240-dp may include a plurality of second patterns 241, and a plurality of second bridge patterns 242 electrically connected to the plurality of second patterns 241. Each of the plurality of second patterns 241 may have a ring shape. The plurality of second patterns 241 and the plurality of second bridge patterns 242 may be electrically connected through contact holes defined in an intermediate insulating layer 203 (see FIG. 6A). Two adjacent second patterns 241 may be spaced apart from each other while interposing one second divided electrode 230-dp and two first bridge patterns 212 between the two adjacent second patterns 241.

According to one or more embodiments of the present disclosure, a third width WT3 of the plurality of first branch parts 220b1 in the second direction DR2 may be greater than a fourth width WT4 of the plurality of second branch parts 220b2 in the first direction DR1. For example, the plurality of first branch parts 220b1 may overlap the plurality of second patterns 241 and dummy patterns surrounded by the plurality of second patterns 241. The overlap area between the second electrode 220 and the fourth electrode 240 may be suitably adjusted by adjusting the third width WT3. Alternatively, the overlap area between the second electrode 220 and the fourth electrode 240 may be suitably adjusted by adjusting the size of an inner diameter of the ring shape of each of the plurality of second patterns 241 surrounding the dummy pattern.

According to one or more embodiments of the present disclosure, each of the plurality of third divided electrodes 240-dp may include the plurality of second patterns 241 and the plurality of second bridge patterns 242 located in different layers, and the plurality of second patterns 241 and the plurality of second bridge patterns 242 may be electrically connected to each other through contacts. In this case, as compared to when the plurality of second patterns 241 and the plurality of second bridge patterns 242 are located in the same layer and are integrally provided, a resistance may relatively increase.

According to one or more embodiments of the present disclosure, the third electrode 230 corresponds to a component to transmit a signal during touch sensing and pen sensing, and the fourth electrode 240 corresponds to a component to form capacitance with the third electrode 230 during pen sensing. Accordingly, it is preferable to reduce a resistance of the third electrode 230 rather than a resistance of the fourth electrode 240. Accordingly, the third electrode 230 may be implemented in the same layer, and the fourth electrode 240 may be implemented in two different layers.

The second bridge pattern 242 may include only one line extending in a first crossing direction CDR1 or a second crossing direction CDR2 in some sections. In this case, the first bridge pattern 212 overlapped with the second bridge pattern 242 may be electrically insulated while crossing from the second bridge pattern 242, in the some sections. Accordingly, the capacitance between the first bridge pattern 212 and the second bridge pattern 242 may be reduced or minimized.

Referring to FIGS. 8B and 9B, each of the plurality of second divided electrodes 230-dp, the plurality of second patterns 241, the plurality of first patterns 211, the second electrode 220, and the plurality of second bridge patterns 242 may have a mesh structure. Each of the mesh structures may include a plurality of mesh lines. Each of the plurality of mesh lines may have a shape extending in a corresponding direction and may be connected to one another. The shape may have various shapes, such as a straight line, a line having a protrusion, or an irregular line. In each of the mesh structures, openings partially surrounded by the mesh lines may be defined (provided or formed). The openings may overlap the emission region PXA (see FIG. 6A), and the mesh lines may overlap the non-emission region NPXA (see FIG. 6A). However, this is not particularly limited thereto.

It is illustrated that the mesh structure may include mesh lines extending in the first crossing direction CDR1 crossing the first direction DR1 and the second direction DR2, and mesh lines extending in the second crossing direction CDR2 crossing the first crossing direction CDR1. However, extending directions of the mesh lines constituting the mesh structure are not particularly limited. For example, the mesh structure may include only mesh lines extending in the first direction DR1 and the second direction DR2, or may include mesh lines extending in the first direction DR1, the second direction DR2, and the first and second crossing directions CDR1 and CDR2. In other words, the mesh structure may be variously modified.

According to one or more embodiments of the present disclosure, a first capacitance may be defined between the first electrode 210 and the third electrode 230, and a second capacitance may be defined between the second electrode 220 and the fourth electrode 240. A size of the first capacitance and a size of the second capacitance may be adjusted by the overlap area between the first electrode 210 and the third electrode 230, and the overlap area between the second electrode 220 and the fourth electrode 240.

According to the present disclosure, as the first and second capacitances increase, an amount of an induced current transmitted from the third electrode 230 to the first electrode 210 may increase, and an amount of an induced current transmitted from the fourth electrode 240 to the second electrode 220 may increase. Accordingly, as the first and second capacitances increase, pen sensing performance of the sensor layer 200 may be improved. In addition, during touch sensing, the first and second capacitances may function as a load. Accordingly, as the first and second capacitances decrease, the touch sensing performance may be improved.

According to the present disclosure, the overlap area between the first electrode 210 and the third electrode 230, and the overlap area between the second electrode 220 and the fourth electrode 240, may be suitably adjusted. Accordingly, the sensor layer 200 having appropriate levels of capacitances based on touch sensitivity and pen sensing sensitivity may be provided. Accordingly, the electronic device ED (see FIG. 3) may be provided with improved pen sensitivity and touch sensitivity.

In addition, according to the present disclosure, an area occupied by components, which are included in the first electrode 210 and the second electrode 220, may be greater than an area occupied by components that are included in the third electrode 230 and the fourth electrode 240, in the second conductive layer SU204 of one sensing unit SU. A change in capacitance caused by the first input 2000 (see FIG. 5) may be greater, as the distance becomes shorter. Accordingly, components to sense the first input 2000 (see FIG. 5) may be located with a larger area in a layer adjacent to a surface of the electronic device ED (see FIG. 3). Accordingly, touch performance may be improved.

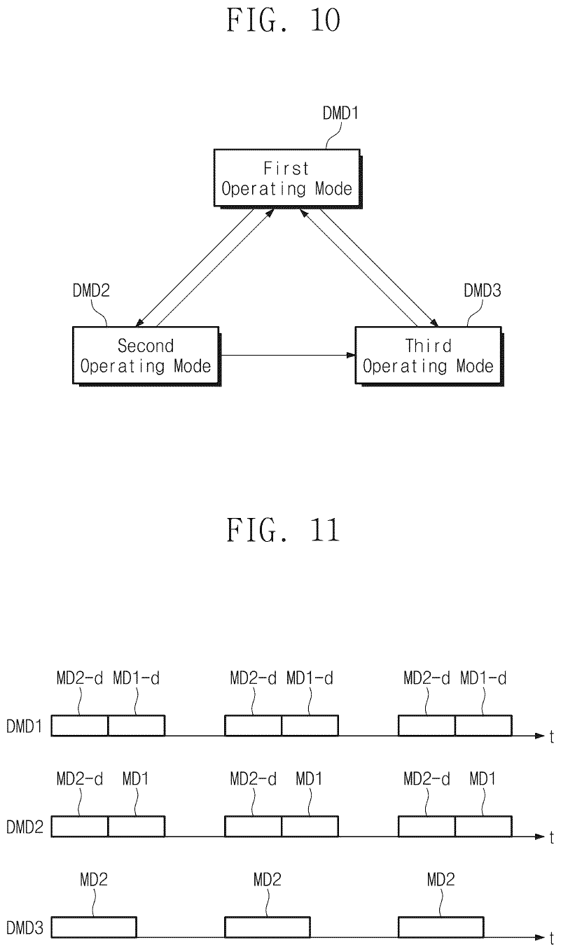

FIG. 10 is a view illustrating an operation of a sensor driver according to one or more embodiments of the present disclosure.

Referring to FIGS. 5 and 10, the sensor driver 200C may be configured to be selectively driven in any one of a first operating mode DMD1, a second operating mode DMD2, and a third operating mode DMD3.

The first operating mode DMD1 may be referred to as a touch-and-pen standby mode, the second operating mode DMD2 may be referred to as a touch-activation-and-pen-standby mode, and the third operating mode DMD3 may be referred to as a pen activation mode. The first operating mode DMD1 may be a mode for waiting for the first input 2000 and the second input 3000. The second operating mode DMD2 may be a mode for sensing the first input 2000 and for waiting for the second input 3000. The third operating mode DMD3 may be a mode for sensing the second input 3000.

According to one or more embodiments of the present disclosure, the sensor driver 200C may initially be driven in the first operating mode DMD1. When the first input 2000 is sensed in the first operating mode DMD1, the sensor driver 200C may be switched (or changed) to the second operating mode DMD2. Alternatively, when the second input 3000 is sensed in the first operating mode DMD1, the sensor driver 200C may be switched (or changed) to the third operating mode DMD3.

According to one or more embodiments of the present disclosure, when the second input 3000 is sensed in the second operating mode DMD2, the sensor driver 200C may be switched to the third operating mode DMD3. When the first input 2000 is released (or not sensed) in the second operating mode DMD2, the sensor driver 200C may be switched to the first operating mode DMD1. When the second input 3000 is released (or not detected) in the third operating mode DMD3, the sensor driver 200C may be switched to the first operating mode DMD1.

FIG. 11 is a view illustrating the operation of a sensor driver according to one or more embodiments of the present disclosure.

Referring to FIGS. 5, 7, 10, and 11, operations in the first to third operating modes DMD1, DMD2, and DMD3 are illustrated in time (t) sequence.

In the first operating mode DMD1, the sensor driver 200C may be repeatedly driven in a second mode MD2-d and a first mode MD1-d. During the second mode MD2-d, the sensor layer 200 may be scan-driven to detect the second input 3000. During the first mode MD1-d, the sensor layer 200 may be scan-driven to detect the first input 2000. Although FIG. 11 illustrates that the sensor driver 200C operates in the first mode MD1-d subsequently after the second mode MD2-d, the sequence is not particularly limited thereto.

In the second operating mode DMD2, the sensor driver 200C may be repeatedly driven in the second mode MD2-d and a first mode MD1. During the second mode MD2-d, the sensor layer 200 may be scan-driven to detect the second input 3000. During the first mode MD1, the sensor layer 200 may be scan-driven to detect coordinates based on the first input 2000.

In the third operating mode DMD3, the sensor driver 200C may be driven in a second mode MD2. During the second mode MD2, the sensor layer 200 may be scan-driven to detect coordinates based on the second input 3000. In the third operating mode DMD3, the sensor driver 200C may not operate in the first mode MD1-d or the first mode MD1 until the second input 3000 is released (or not detected).

In the first mode MD1-d and the first mode MD1, the third electrodes 230 and the fourth electrodes 240 may both be grounded or applied with a constant voltage. Alternatively, in the first mode MD1-d and the first mode MD1, the third electrodes 230 and the fourth electrodes 240 may both be floated (or electrically floated). Alternatively, in the first mode MD1-d and the first mode MD1, signals in phase with transmission signals provided to the first electrodes 210 may be applied to the third electrodes 230 and the fourth electrodes 240. In this case, touch noise introduced through the third electrodes 230 and the fourth electrodes 240 may be reduced or prevented.

In the second mode MD2-d and the second mode MD2, one end of each of the third electrodes 230 and the fourth electrodes 240 may be floated. In addition, in the second mode MD2-d and the second mode MD2, an opposite end of each of the third electrodes 230 and the fourth electrodes 240 may be grounded or floated. Accordingly, compensation of sensing signals may be improved or maximized through the coupling between the first electrodes 210 and the third electrodes 230 and the coupling between the second electrodes 220 and the fourth electrodes 240.

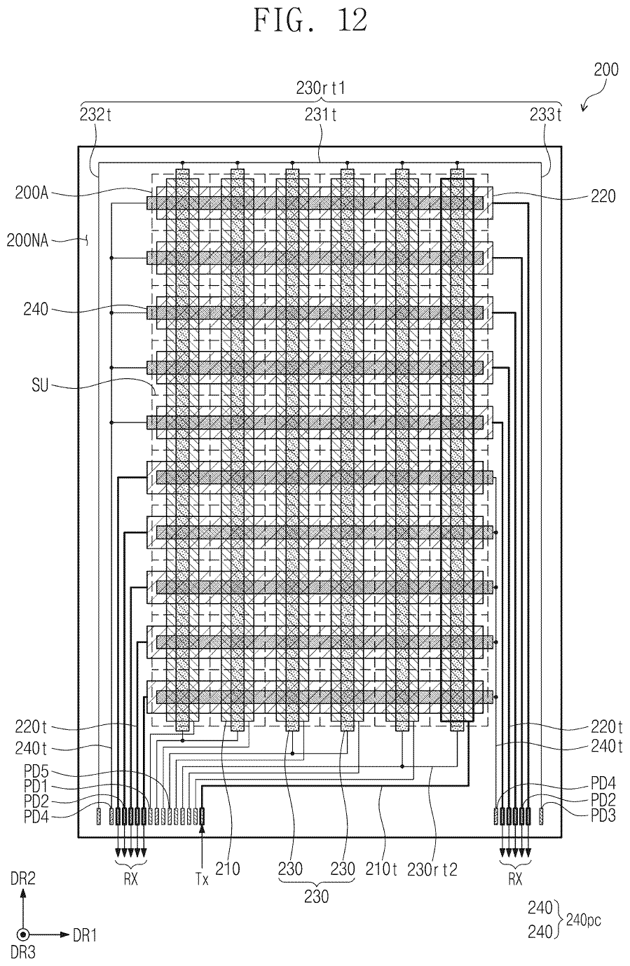

FIG. 12 is a view to describe a first mode according to one or more embodiments of the present disclosure. In the following description made with reference to FIG. 12, the components that have been described with reference to FIG. 7 will be assigned with the same reference numerals, and the details thereof will be omitted.

Referring to FIGS. 5, 11, and 12, the first mode MD1-d of the first driving mode DMD1 and the first mode MD1 of the second driving mode DMD2 may include a mutual-capacitance-detecting mode. FIG. 12 is a view to describe the mutual-capacitance-detecting mode in the first mode MD1-d of the first driving mode DMD1 and the first mode MD1 of the second driving mode DMD2.

In the mutual-capacitance-detecting mode, the sensor driver 200C may sequentially provide transmit signals TX to the first electrodes 210, and may detect coordinates for the first input 2000 by using receive signals RX detected through the second electrodes 220. For example, the sensor driver 200C may be configured to calculate input coordinates by sensing changes in mutual capacitance between the first electrodes 210 and the second electrodes 220.

FIG. 12 illustrates that the transmit signal TX, which is provided to one first electrode 210, and the receive signals RX are output from the second electrodes 220. For the clarity of signal representation, one first electrode 210 to which the transmit signal TX is provided is expressed in a bold line in FIG. 12. The sensor driver 200C may detect input coordinates for the first input 2000 by sensing changes in capacitance between the first electrode 210 and each of the second electrodes 220.

According to one or more embodiments of the present disclosure, at least one of the first mode MD1-d of the first driving mode DMD1 or the first mode MD1 of the second driving mode DMD2 may further include a self-capacitance-detecting mode. In the self-capacitance-detecting mode, the sensor driver 200C may output driving signals to the first electrodes 210 and the second electrodes 220, and may be configured to calculate input coordinates by sensing changes in capacitance of each of the first electrodes 210 and the second electrodes 220.

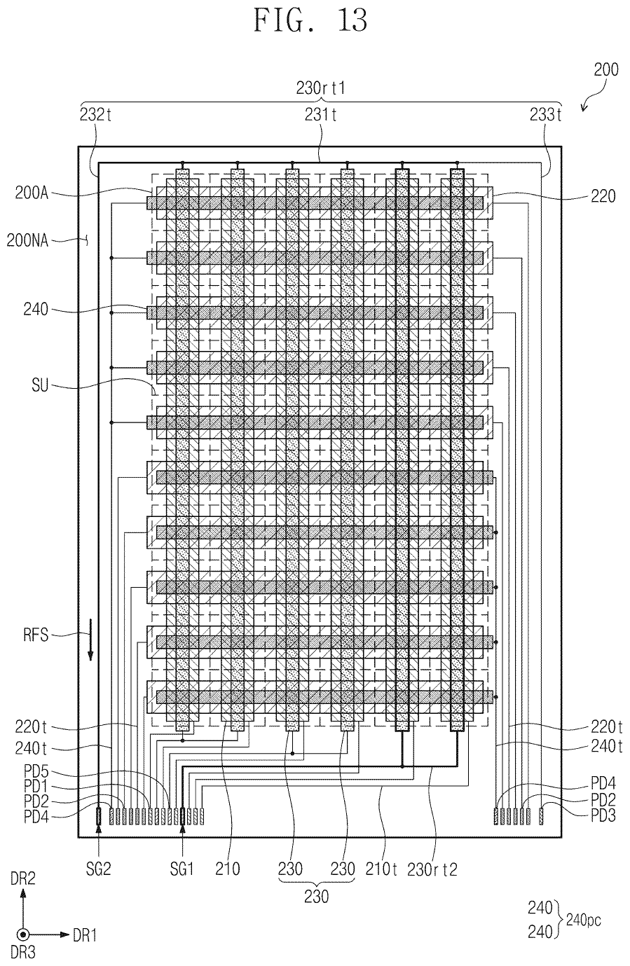

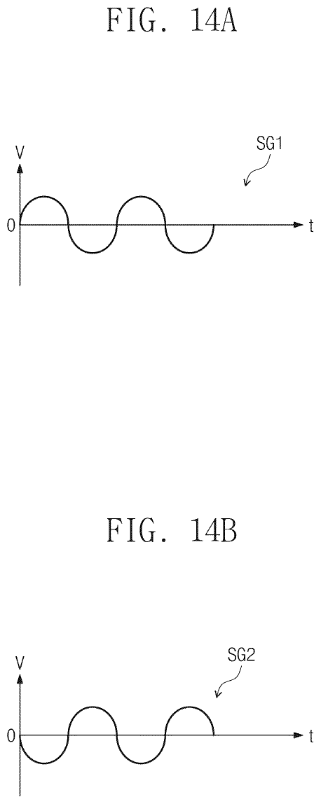

FIG. 13 is a view to describe a second mode, such as a charging-driving mode, according to one or more embodiments of the present disclosure. FIG. 14A is a graph illustrating a waveform of a first signal according to one or more embodiments of the present disclosure, and FIG. 14B is a graph illustrating a waveform of a second signal according to one or more embodiments of the present disclosure. In the following description made with reference to FIG. 13, the components that have been described with reference to FIG. 7 will be assigned with the same reference numerals, and the details thereof will be omitted.

Referring FIGS. 13, 14A, and 14B, the second mode MD2 may include the charging-driving mode. The charging-driving mode may include a searching-charging-driving mode and a tracking-charging-driving mode.

The searching-charging-driving mode may be a driving mode before sensing a position of a pen. Accordingly, a first signal SG1 or a second signal SG2 may be sequentially provided through all channels included in the sensor layer 200. In other words, the entire region of the sensor layer 200 may be sequentially scanned in the searching-charging-driving mode. When the input device PN is sensed in the searching-charging-driving mode, the sensor layer 200 may enter the tracking-charging-driving mode. For example, in the tracking-charging-driving mode, the sensor driver 200C may sequentially output the first signal SG1 and the second signal SG2 to a region overlapped with a position at which the input device PN is sensed, rather than to the entire region of the sensor layer 200.

In the charging-driving mode, the sensor driver 200C may apply the first signal SG1 to one of the third pads PD3 and the fifth pads PD5, and may apply the second signal SG2 to another of the third pads PD3 and the fifth pads PD5. The second signal SG2 may be a signal having a phase inverse to a phase of the first signal SG1. For example, the first signal SG1 may be a sine wave signal.

Because the first signal SG1 and the second signal SG2 are applied through at least two pads, the current RFS may have a current path flowing from one pad to another pad. In addition, because the first signal SG1 and the second signal SG2 are sine wave signals in inverse-phase relation, a direction of the current RFS may periodically vary. According to one or more embodiments of the present disclosure, the first signal SG1 and the second signal SG2 may be square wave signals in inverse-phase relation.

When the first signal SG1 and the second signal SG2 are in inverse-phase relation, noise caused in the display layer 100 (see FIG. 5) by the first signal SG1 may be canceled by noise caused by the second signal SG2. Accordingly, flicker may be reduced or prevented in display layer 100, and display quality of the display layer 100 may be improved.

According to one or more embodiments of the present disclosure, the first signal SG1 may be a sine wave signal. However, the present disclosure is not limited thereto. For example, the first signal SG1 may be a square wave signal. In addition, the second signal SG2 may have a corresponding constant voltage. For example, the second signal SG2 may be a ground voltage. In other words, the pad to which the second signal SG2 is applied may be regarded as being grounded. Even in this case, the current RFS may flow from one pad to another pad. In addition, although one of the pads is grounded, the direction of the current RFS may periodically vary because the first signal SG1 is a sine wave signal or a square wave signal.

FIG. 13 illustrates that the second signal SG2 is provided to one third pad PD3 connected to one third trace line 230rt1, and the first signal SG1 is provided to one fifth pad PD5 connected to the third electrode 230. The current RFS may flow through a current path defined by the fifth pad PD5, the fifth trace line 230rt2 connected to the fifth pad PD5, the third electrode 230, a portion of the third trace line 230rt1 connected to the third pad PD3, and the third pad PD3. The current path may have a coil shape. Accordingly, in the charging-driving mode of the second mode, a resonant circuit of the input device PN may be charged through the current path.

According to the present disclosure, a current path having a loop coil pattern may be implemented by components included in the sensor layer 200. Accordingly, the electronic device ED (see FIG. 3) may charge the input device PN by using the sensor layer 200. Accordingly, because a component having a coil to charge the input device PN may not need to be additionally provided, the increase in thickness, the increase in weight, and/or the decrease in flexibility of the electronic device ED may be reduced or prevented.

In the charging-driving mode, the first electrodes 210, the second electrodes 220, and the fourth electrodes 240 may be grounded, may be applied with a constant voltage, or may be electrically floated. For example, the first electrodes 210, the second electrodes 220, and the fourth electrodes 240 may be floated. In this case, the current RFS may not flow through the first electrodes 210, the second electrodes 220, and the fourth electrodes 240.

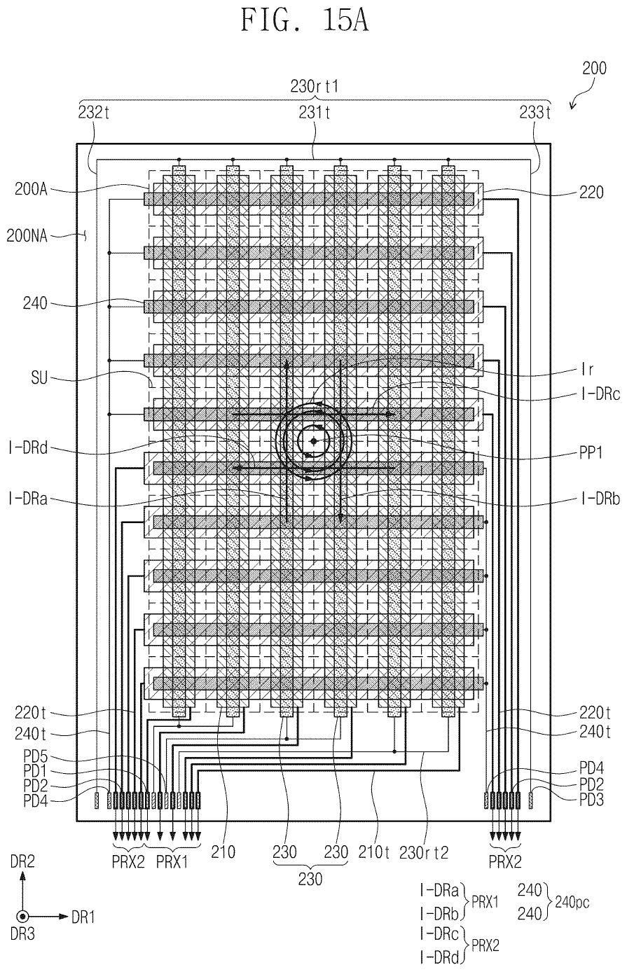

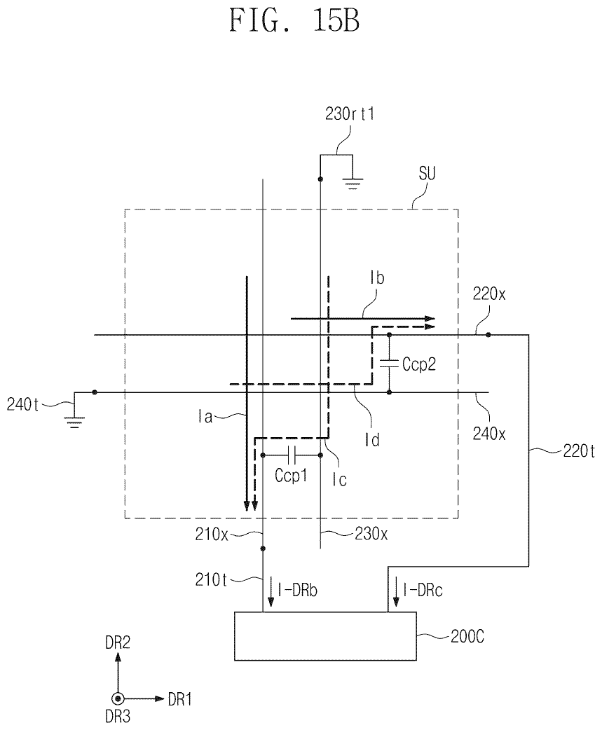

FIG. 15A is a view to describe a second mode according to one or more embodiments of the present disclosure. In the following description made with reference to FIG. 15A, the components that have been described with reference to FIG. 7 will be assigned with the same reference numerals, and the details thereof will be omitted.

Referring to FIGS. 5 and 15A, the second mode may include a charging-driving mode and a pen-sensing-driving mode (e.g., a charging-and-sensing mode). For example, FIG. 15A is a view to describe the pen-sensing-driving mode.

An RLC resonant circuit of the input device PN may emit a magnetic field having a resonant frequency while discharging charged electric charges. The input device PN may be positioned near a first position PP1. While discharging the charged electric charges, a current Ir may flow through a coil of an inductor L (see FIG. 5) of the RLC resonant circuit of the input device PN. The magnetic field may be formed by the current Ir. Induced currents I-DRa, I-DRb, I-DRc, and I-DRd (which includes the first induced current I-DRa, the second induced current I-DRb, the third induced current I-DRc, and the fourth induced current I-DRd) may be generated in the plurality of first electrodes 210 and in the plurality of second electrodes 220 by the current Ir. The induced currents I-DRa, I-DRb, I-DRc, and I-DRd may be formed in a direction opposite to the direction of the current Ir.

The first induced current I-DRa may be formed in the second direction DR2 in the first electrodes 210 positioned on a left side of first position PP1. The second induced current I-DRb may be formed in a direction opposite to the second direction DR2 in the first electrodes 210 positioned on a right side of the first position PP1.

A first sensing signal PRX1 may include the first induced current I-DRa and the second induced current I-DRb.

The third induced current I-DRc may be formed in the first direction DR1 in the second electrodes 220 positioned on an upper side of the first position PP1. The fourth induced current I-DRd may be formed in a direction opposite to the first direction DR1 in the second electrodes 220 positioned on a lower side of first position PP1.

A second sensing signal PRX2 may include the third induced current I-DRc and the fourth induced current I-DRd.

The sensor driver 200C may receive the first sensing signal PRX1 from a first electrode 210x (see FIG. 15B), and may receive the second sensing signal PRX2 from a second electrode 220x (see FIG. 15B). The sensor driver 200C may detect coordinate information of the input device PN, based on the first sensing signal PRX1 and/or the second sensing signal PRX2.

FIG. 15B is a view to describe the second mode based on one sensing unit according to one or more embodiments of the present disclosure.

FIG. 15B illustrates one sensing unit SU through which the first and second induced currents I-DRa and I-DRb generated by the input device PN flow.

Referring to FIGS. 15A and 15B, routing directions of one electrode and another electrode of the sensor layer 200, which are overlapped with each other, may be mutually different from each other. For example, the routing direction of the first electrode 210x may differ from the routing direction of the third electrode 230x. In addition, the routing direction of the second electrode 220x may differ from the routing direction of the fourth electrode 240x. For example, in FIG. 15B, the first electrode 210x and the first trace line 210t may be connected to each other at a lower side of the sensing unit SU, and the third electrode 230x and the third trace line 230rt1 may be connected to each other at an upper side of the sensing unit SU. The second electrode 220x and the second trace line 220t may be connected to each other at a right side of the sensing unit SU, and the fourth electrode 240x and the fourth trace line 240t may be connected to each other at a left side of the sensing unit SU.

The RLC resonant circuit of the input device PN may emit a magnetic field having a resonant frequency while discharging charged electric charges. A first sub-current Ia may be generated in the first electrode 210x, and a second sub-current Ib may be generated in the second electrode 220x by the magnetic field provided from the input device PN. In addition, a third sub-current Ic may be generated in the third electrode 230x, and a fourth sub-current Id may be generated in the fourth electrode 240x.

A first coupling capacitance Ccp1 may be formed between the third electrode 230x and the first electrode 210x, and a second coupling capacitance Ccp2 may be formed between the fourth electrode 240x and the second electrode 220x.

The third sub-current Ic may be transmitted to the first electrode 210x through the first coupling capacitance Ccp1, and the fourth sub-current Id may be transmitted to the second electrode 220x through the second coupling capacitance Ccp2.

The sensor driver 200C may receive the second induced current I-DRb based on the first sub-current Ia and the third sub-current Ic from the first electrode 210x and may receive the third induced current I-DRc based on the second sub-current Ib and the fourth sub-current Id from the second electrode 220x. The second induced current I-DRb may include the first sub-current Ia and the third sub-current Ic, and the third induced current I-DRc may include the second sub-current Ib and the fourth sub-current Id.

The sensor driver 200C may detect the coordinate information of the input device PN based on the first sensing signal PRX1 including the second induced current I-DRb and the second sensing signal PRX2 including the third induced current I-DRc.

The sensor driver 200C may receive the first sensing signal PRX1 from the first electrode 210x, and may receive the second sensing signal PRX2 from the second electrode 220x. In this case, one ends of the third electrode 230x and the fourth electrode 240x may be floated. Accordingly, compensation of sensing signals may be improved or maximized by the coupling between the first electrode 210x and the third electrode 230x, and by the coupling between the second electrode 220x and the fourth electrode 240x.

In addition, other ends of the third electrode 230x and the fourth electrode 240x may be grounded or floated. Accordingly, the third sub-current Ic and the fourth sub-current Id may be sufficiently transmitted to the first electrode 210x and the second electrode 220x by the coupling between the first electrode 210x and the third electrode 230x and by the coupling between the second electrode 220x and the fourth electrode 240x.

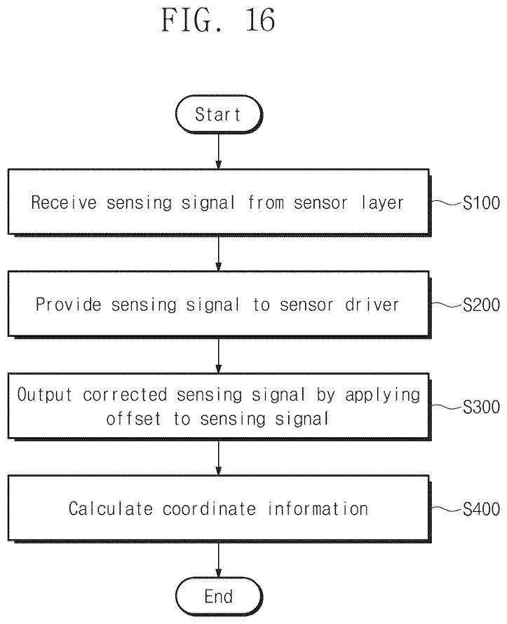

FIG. 16 is a flowchart illustrating a method for driving an electronic device according to one or more embodiments of the present disclosure.

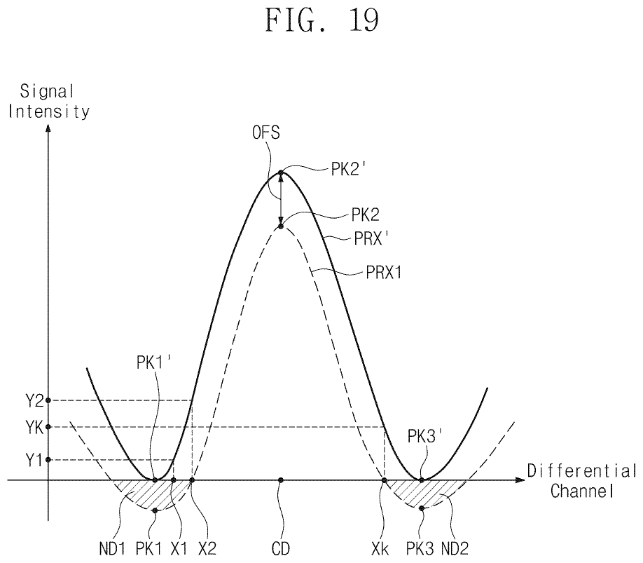

Referring FIGS. 5, 15A, and 16, a method for driving an electronic device according to one or more embodiments of the present disclosure may include the operations for receiving the sensing signals PRX1 and PRX2 based on the induced currents I-DRa, I-DRb, I-DRc, and I-DRd, which are induced by the input device PN, from the sensor layer 200 (S100); providing the sensing signals PRX1 and PRX2 to the sensor driver (S200); outputting a sensing signal PRX′ corrected by applying an offset OFS (see FIG. 19) to the sensing signals PRX1 and PRX2 sensed for the input device PN in the sensor layer 200 (S300); and calculating coordinate information CD based on the corrected sensing signal PRX′ (S400). Details thereof will be described below.

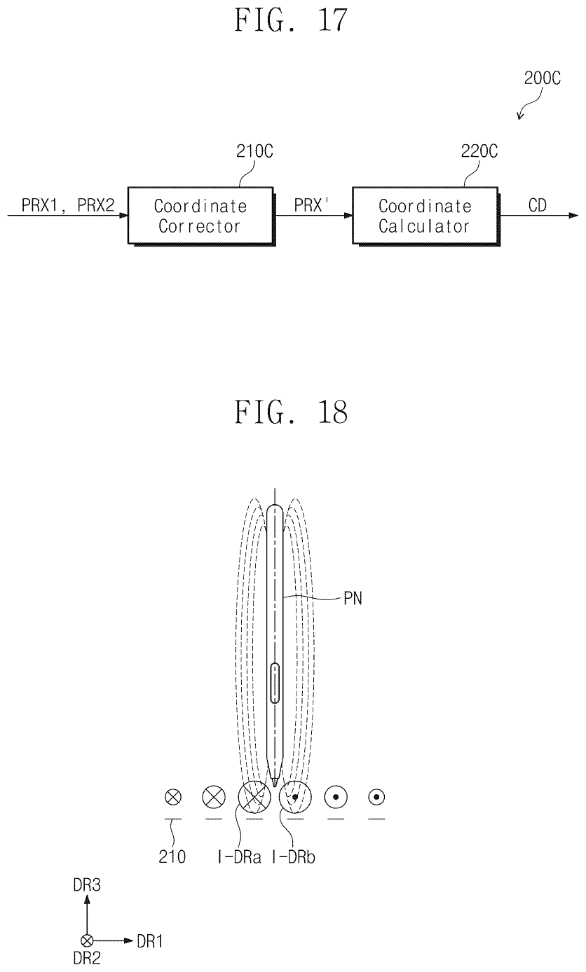

FIG. 17 is a block diagram of a sensor driver according to one or more embodiments of the present disclosure.

Referring to FIGS. 5 and 17, the sensor driver 200C may receive the first sensing signal PRX1 and the second sensing signal PRX2 from the sensor layer 200. The sensor driver 200C may calculate the coordinate information CD of the input device PN.

The sensor driver 200C may include a coordinate corrector 210C and a coordinate calculator 220C.

The coordinate corrector 210C may output a corrected sensing signal PRX′ by applying the offset to the sensing signals PRX1 and PRX2, which are sensed for the input device PN in the sensor layer 200.

The coordinate calculator 220C may receive the corrected sensing signal PRX′. The coordinate calculator 220C may calculate the coordinate information CD of the input device PN based on the corrected sensing signal PRX′.

FIG. 18 is a view illustrating the magnitude and the direction of an induced current generated in the input device PN and the first electrodes according to one or more embodiments of the present disclosure.

Referring to FIGS. 15A and 18, the first induced current I-DRa may flow in a direction of entering the cross-section (e.g., in a direction into the figure), based on a position of the input device PN. The second induced current I-DRb may flow in a direction of exiting from the cross-section (e.g., in a direction out from the figure), based on a position of the input device PN.

A size of a circle representing a direction of the first and second induced currents I-DRa and I-DRb may correspond to a magnitude of the first and second induced currents I-DRa and I-DRb. In other words, as a distance from the input device PN increases, the magnitude of the induced currents I-DRa and I-DRb may decrease.

When the input device PN is provided without tilting and is provided in the direction parallel to the third direction DR3, the magnitude of the first and second induced currents I-DRa and I-DRb may be laterally symmetric to each other about the position of the input device PN.

Although FIG. 18 illustrates the first electrodes 210, the description about the induced currents I-DRa and I-DRb according to one or more embodiments of the present disclosure may be identically applied to induced currents I-DRc and I-DRd formed in the second electrodes 220.

FIG. 19 is a graph of sensing current values illustrating sensing signals and corrected sensing signals obtained from differential pairs of channels according to one or more embodiments of the present disclosure.

Referring to FIGS. 16 to 19, the coordinate corrector 210C may receive the sensing signals PRX1 and PRX2 from the sensor layer 200 (see FIG. 5), based on currents induced by the input device PN (S100). Although the description is made with reference to FIG. 19 by way of example while focusing on the first sensing signal PRX1 for determining an X-coordinate of the coordinate information CD, coordinate information CD about the second sensing signal PRRX2 for determining a Y-coordinate will be calculated in the same manner.

The first sensing signal PRX1 may be generated from a differential signal obtained by differentially sensing channels that are adjacent to each other or that are spaced apart from each other, based on currents induced to the sensor layer 200 by the input device PN. The first sensing signal PRX1 may be generated by differentially sensing channels, which are adjacent to each other or spaced apart from each other, among the plurality of first electrodes 210. The differentially sensed channels may be referred to as differential channels.

The first sensing signal PRX1 may be provided to the sensor driver 200C (S200). The coordinate corrector 210C may obtain data about the differentially sensed current. The data may be used for processing information about an input by the input device PN. The first sensing signal PRX1 may include the data.

In a sensing current graph illustrating the first sensing signal PRX1 and the corrected sensing signal PRX′, a horizontal axis represents differential channels, and a vertical axis represents a signal magnitude.

The first sensing signal PRX1 may include a plurality of peak values PK1, PK2, and PK3. The plurality of peak values PK1, PK2, and PK3 may include the first peak value PK1, the second peak value PK2, and the third peak value PK3.

Magnitudes of the first peak value PK1 and the third peak value PK3 may be negative values, and a magnitude of the second peak value PK2 may be a positive value. The first peak value PK1 and the third peak value PK3 may be spaced apart from each other, while interposing the second peak value PK2 between the first peak value PK1 and the third peak value PK3.

The magnitude of the second peak value PK2 may be the maximum value in the sensing current graph. The magnitudes of the first peak value PK1 and the third peak value PK3 may be the smallest/minimum value(s) and/or the second smallest value in the sensing current graph. For example, the magnitudes of the first peak value PK1 and the third peak value PK3 may be the same.

The coordinate corrector 210C may output the corrected sensing signal PRX′ by applying the offset OFS to the first sensing signal PRX1 (S300).

The offset OFS may be calculated based on the second smallest value among the peak values of the first sensing signal PRX1. The offset OFS may be calculated based on the first peak value PK1 and/or the third peak value PK3. For example, the offset OFS may have a magnitude equal to magnitudes of the first peak value PK1 and the third peak value PK3.

The coordinate corrector 210C may identically apply the offset OFS to all data of the first sensing signal PRX1.

The corrected sensing signal PRX′ may include a plurality of corrected peak values PK1′, PK2′, and PK3′. The plurality of corrected peak values PK1′, PK2′, and PK3′ may include the first corrected peak value PK1′, the second corrected peak value PK2′, and the third corrected peak value PK3′.

The first corrected peak value PK1′ may correspond to the first peak value PK1. The second corrected peak value PK2′ may correspond to the second peak value PK2. The third corrected peak value PK3′ may correspond to the third peak value PK3.

At least one of a magnitude of the first corrected peak value PK1′ or a magnitude of the third corrected peak value PK3′ may be zero. For example, the magnitudes of both the first corrected peak value PK1′ and the third corrected peak value PK3′ in the corrected sensing signal PRX′ may be zero.

The number of negative data in the corrected sensing signal PRX′ may be less than the number of negative data in the first sensing signal PRX1.

The coordinate calculator 220C may calculate the coordinate information CD based on the corrected sensing signal PRX′ (S400).

The coordinate calculator 220C may perform a center-of-mass manner using “n” pieces of data (where “n” is a natural number) located on opposite sides of the second corrected peak value PK2′.

$$X coordinate = \frac{( Y 1 \times X 1 ) + ( Y 2 \times X 2 ) + … + ( Y k \times Xk )}{Y 1 + Y 2 + … + Yk} \qquad Equation 1$$

Equation 1 represents a center-of-mass manner, and the X-coordinate may indicate an X-coordinate of the coordinate information CD. When n data points respectively on both sides of the second corrected peak value PK2′ are extracted, the data may include (X1, Y1), (X2, Y2), and (Xk, Yk), where “k” is a natural number.

The coordinate calculator 220C may disregard data having a negative value among the data of the corrected sensing signal PRX′.

The coordinate calculator 220C may calculate the X-coordinate of the input device PN based on the second corrected peak value PK2′. The coordinate calculator 220C may calculate the X-coordinate from first electrodes 210 and the Y-coordinate from the second electrodes 220. The coordinate information CD may include the X-coordinate and the Y-coordinate.

According to the present disclosure, the coordinate corrector 210C may apply the offset OFS to the sensing signals PRX1 and PRX2 to reduce regions ND1 and ND2 having negative data from the data obtained from the sensing signals PRX1 and PRX2. The number of negative data in the corrected sensing signal PRX′ may be less than the number of negative data in the first sensing signal PRX1. Accordingly, as the number of data usable by the coordinate calculator 220C for coordinate calculation may increase, the accuracy of the coordinate information CD may be improved. Accordingly, the electronic device ED (see FIG. 5), which is improved in coordinate reliability, and the method for driving the same may be provided.

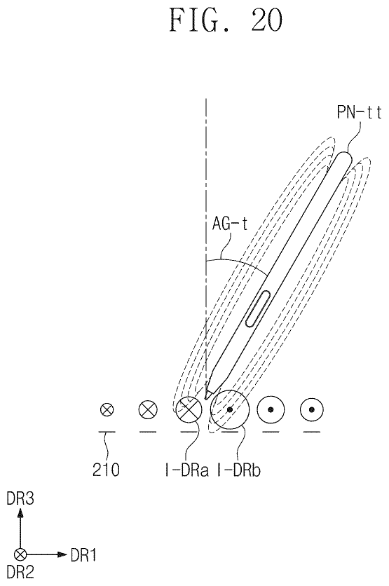

FIG. 20 is a view illustrating a magnitude and a direction of induced currents generated between an input device and first electrodes according to one or more embodiments of the present disclosure.

Referring to FIG. 20, a first induced current I-DRa may flow in a direction of entering a cross-section (e.g., into the figure), based on the position of an input device PN-tt. A second induced current I-DRb may flow in a direction of exiting from the cross-section, based on the position of an input device PN-tt.

Sizes of circles representing directions of the first and second induced currents I-DRa and I-DRb may correspond to the magnitudes of the first and second induced currents I-DRa and I-DRb. In other words, as a distance from the input device PN increases, the magnitudes of the induced currents I-DRa and I-DRb may decrease.

When the input device PN-tt is tilted at a corresponding angle AG-t, the intensity of the induced current I-DRb in the tilted direction may be greater than the intensity of the induced current I-DRa in an opposite direction.

As a distance from the input device PN-tt increases, the magnitudes of the induced currents I-DRa and I-DRb may decrease.

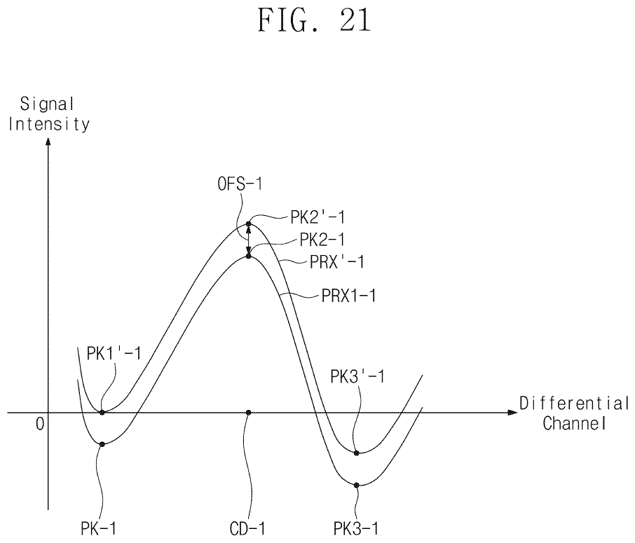

FIG. 21 is a graph of sensing current values illustrating sensing signals and corrected sensing signals obtained from differential pairs of channels according to one or more embodiments of the present disclosure. In the following description made with reference to FIG. 21, the components that have been described with reference to FIG. 19 will be assigned with the same reference numerals, and the details thereof will be omitted.

Referring to FIGS. 16, 17, 20, and 21, a first sensing signal PRX1-1 may be provided to the sensor driver 200C (S200).

The first sensing signal PRX1-1 may include a plurality of peak values PK1-1, PK2-1, and PK3-1. The plurality of peak values PK1-1, PK2-1, and PK3-1 may include the first peak value PK1-1, the second peak value PK2-1, and the third peak value PK3-1.

Magnitudes of the first peak value PK1-1 and the third peak value PK3-1 may be negative values, and a magnitude of the second peak value PK2-1 may be a positive value. The first peak value PK1-1 and the third peak value PK3-1 may be spaced apart from each other while interposing the second peak value PK2-1 between the first peak value PK1-1 and the third peak value PK3-1.

The magnitude of the second peak value PK2-1 may be the maximum value in the sensing current graph. The magnitudes of the first peak value PK1-1 and the third peak value PK3-1 may be the smallest value(s) and/or the second smallest value in the sensing current graph. The magnitudes of the first peak value PK1-1 and the third peak value PK3-1 may be different from each other. For example, the magnitude of the first peak value PK1-1 may be greater than the magnitude of the third peak value PK3-1. However, this is provided only for the illustrative purpose. For example, the magnitudes of the first peak value PK1-1 and the third peak value PK3-1 according to one or more embodiments of the present disclosure may vary depending on a titling direction of the input device PN-tt. For example, when the input device PN-tt is tilted in the opposite direction, the magnitude of the third peak value PK3-1 may be greater than the magnitude of the first peak value PK1-1.

The coordinate corrector 210C may output a corrected sensing signal PRX′-1 by applying an offset OFS-1 to the first sensing signal PRX1-1 (S300).

The offset OFS-1 may be calculated based on a greater value of the magnitude of the first peak value PK1-1 and the magnitude of the third peak value PK3-1. For example, the offset OFS-1 may be calculated based on the magnitude of the first peak value PK1-1.

The coordinate corrector 210C may identically apply the offset OFS-1 to all data of the first sensing signal PRX1-1.

The corrected sensing signal PRX′-1 may include a plurality of corrected peak values PK1′-1, PK2′-1, and PK3′-1. The plurality of corrected peak values PK1′-1, PK2′-1, and PK3′-1 may include the first corrected peak value PK1′-1, the second corrected peak value PK2′-1, and the third corrected peak value PK3′-1.

The first corrected peak value PK1′-1 may correspond to the first peak value PK1-1. The second corrected peak value PK2′-1 may correspond to the second peak value PK2-1. The third corrected peak value PK3′-1 may correspond to the third peak value PK3-1.

The magnitude of the first corrected peak value PK1′-1 may be zero. The magnitude of the third corrected peak value PK3′-1 may be a negative value.

The number of negative data in the corrected sensing signal PRX′-1 may be less than the number of negative data in the first sensing signal PRX1-1.

The coordinate calculator 220C may calculate coordinate information CD-1 based on the corrected sensing signal PRX′-1 (S400). The coordinate calculator 220C may disregard data having negative values among the data of the corrected sensing signal PRX′-1.

According to the present disclosure, the coordinate corrector 210C may apply the offset OFS-1 to the first sensing signal PRX1-1. The number of negative data in the corrected sensing signal PRX′-1 may be less than the number of negative data in the first sensing signal PRX1-1. Accordingly, as the number of data usable by the coordinate calculator 220C for coordinate calculation may increase, the accuracy of coordinate information CD-1 may be improved. Accordingly, the electronic device ED (see FIG. 5), which is improved in coordinate reliability, and a method for driving the same may be provided.

Unlike the present disclosure, when the offset OFS-1 is calculated based on the smallest value among the peak values PK1-1, PK2-1, and PK3-1, overall data magnitude of the corrected sensing signal PRX′-1 may increase, so the accuracy in calculation may be degraded. However, according to the present disclosure, the offset OFS-1 may be calculated based on a greater value of the magnitude of the first peak value PK1-1 and the magnitude of the third peak value PK3-1. In other words, the offset OFS-1 may be calculated based on a second smallest value among the peak values PK1-1, PK2-1, and PK3-1. The data of the corrected sensing signal PRX′-1 may have a magnitude suitable for suitably measuring coordinate information CD-1. Accordingly, the electronic device ED (see FIG. 5) improved in coordinate reliability and a method for driving the same may be provided.

As described above, the coordinate corrector may apply the offset to the sensing signal to reduce a region of negative data from data obtained from the sensing signal. The number of negative data in the corrected sensing signal may be less than the number of the negative data of the first sensing signal. As data usable to calculate coordinates by the coordinate calculator increases, the accuracy of the coordinate information may be improved. Accordingly, the electronic device improved in coordinate reliability and the method for driving the electronic device may be provided.

Although one or more embodiments of the present disclosure has been described for illustrative purposes, those skilled in the art will appreciate that various modifications, and substitutions are possible, without departing from the scope and spirit of the present disclosure as disclosed in the accompanying claims.

Accordingly, the aspects of the present disclosure are not limited to the detailed description of this specification, but should be defined by the claims.

While the present disclosure has been described with reference to embodiments thereof, it will be apparent to those of ordinary skill in the art that various changes and modifications may be made thereto without departing from the spirit and scope of the present disclosure as set forth in the following claims, with functional equivalents thereof to be included therein.

What is claimed is:

1. An electronic device comprising:
a display layer;
a sensor layer above the display layer; and
a sensor driver configured to drive the sensor layer, and comprising:
a coordinate corrector configured to output a corrected sensing signal by applying an offset to a sensing signal for an input device sensed in the sensor layer; and
a coordinate calculator configured to calculate coordinate information of the input device based on the corrected sensing signal, and
wherein a number of negative data in the corrected sensing signal is less than a number of negative data in the sensing signal.

2. The electronic device of claim 1, wherein the sensing signal is generated from a differential signal obtained by differentially sensing channels based on a current induced to the sensor layer by the input device.

3. The electronic device of claim 1, wherein the sensing signal comprises:
a first peak value having a magnitude with a negative value;
a second peak value having a magnitude with a positive value; and
a third peak value having a magnitude with a negative value.

4. The electronic device of claim 3, wherein the offset is based on the first peak value or the third peak value.

5. The electronic device of claim 3, wherein the offset is based on a greater value of the magnitude of the first peak value or the magnitude of the third peak value.

6. The electronic device of claim 3, wherein the first peak value and the third peak value have a same magnitude.

7. The electronic device of claim 6, wherein the offset is substantially equal to the magnitude of the first peak value and the magnitude of the third peak value.

8. The electronic device of claim 3, wherein the corrected sensing signal comprises:
a first corrected peak value corresponding to the first peak value;
a second corrected peak value corresponding to the second peak value; and
a third corrected peak value corresponding to the third peak value, and
wherein at least one of a magnitude of the first corrected peak value or a magnitude of the third corrected peak value has a value of zero.

9. The electronic device of claim 8, wherein the magnitude of the first corrected peak value has a value of zero, and
wherein the magnitude of the third corrected peak value has a negative value.

10. The electronic device of claim 8, wherein the coordinate calculator is configured to perform a center-of-mass manner using n pieces of data respectively at opposite sides of the second corrected peak value.

11. The electronic device of claim 1, wherein the coordinate calculator is configured to disregard data having a negative value among data of the corrected sensing signal.

12. The electronic device of claim 1, wherein the coordinate corrector is configured to identically apply the offset to all data of the sensing signal.

13. The electronic device of claim 1, wherein the sensor layer comprises:
first electrodes extending in a first direction;
second electrodes extending in a second direction crossing the first direction; and
third electrodes extending in the first direction, and insulated from the second electrodes.

14. The electronic device of claim 1, wherein the sensor driver is configured to drive a first mode for sensing a touch, or a second mode for sensing the input device and comprising a charging-and-sensing mode.

15. The electronic device of claim 14, wherein the second mode comprises a charging-driving mode and a pen-sensing-driving mode, and
wherein the coordinate information of the input device is calculated in the pen-sensing-driving mode.

16. A method for driving an electronic device, the method comprising:
receiving a sensing signal from a sensor layer based on a current induced by an input device;
providing the sensing signal to a sensor driver;
outputting a corrected sensing signal by applying an offset to the sensing signal; and
calculating coordinate information based on the corrected sensing signal,
wherein a number of negative data distributed in the corrected sensing signal is less than a number of negative data distributed in the sensing signal.

17. The method of claim 16, wherein the sensing signal comprises:
a first peak value having a magnitude with a negative value;
a second peak value having a magnitude with a positive value; and
a third peak value having a magnitude with a negative value.

18. The method of claim 17, further comprising calculating the offset based on the first peak value or the second peak value.

19. The method of claim 17, further comprising calculating the offset based on a greater value of the magnitude of the first peak value or the magnitude of the third peak value.

20. The method of claim 17, wherein the corrected sensing signal comprises:
a first corrected peak value corresponding to the first peak value;
a second corrected peak value corresponding to the second peak value; and
a third corrected peak value corresponding to the third peak value, and
wherein the calculating of the coordinate information comprises performing a center-of-mass manner using n pieces of data respectively on opposite sides of the second corrected peak value.
